(19) United States
(12) Patent Application Publication
(10) Pub. No.: US 2005/0226408 A1
(43) Pub. Date: Oct. 13, 2005

(54) Apparatus and method for encryption and decryption

(76) Inventor: Jimmy Christian Hotz, Thousand Oaks,, CA (US)

Correspondence Address: David B Ritchie;Thelen Reid & Priest, PO Box 640640, San Jose, CA, 95164-0640, US

(21) Appl. No.: 10/522,509

(22) PCT Filed: Jul. 25, 2003
(86) PCT No.: PCT/US03/23473

§ 371 Date: Jan. 26, 2005

Related U.S. Application Data
(60) Provisional application No. 60/399,092, filed on Jul. 27, 2002.

(51) Int. Cl. H04K 1/00

(52) U.S. Cl. 380/28

(57) ABSTRACT

An apparatus and method for encrypting/decrypting data include (a) a first plurality of encryption tables, each of the encryption tables being capable of transforming a data value into an encrypted/decrypted value, the data value corresponding to a unit of the data, the encrypted/decrypted value corresponding to a unit of encrypted/decrypted data, (b) a second plurality of selection tracks, each of the selection tracks including a series of values having a certain pattern, (c) a track mixer coupled to the second plurality of selection tracks, adapted to combine corresponding values of the selection tracks to produce a series of combined values, and (d) an encryption/decryption module coupled to the first plurality of encryption tables and the track mixer, adapted to transform each unit of the data into a unit of encrypted/decrypted data using an encryption table selected for that unit according to a combined value in the series of combined values.

### PRIORITY CLAIM

This application claims the benefit of provisional U.S. Patent Application Ser. No. 60/399,092 filed on Jul. 27, 2002 in the name of the same inventor.

### FIELD OF THE INVENTION

The present invention relates to cryptography and cryptographic systems. More particularly, the present invention relates to an apparatus and method for encrypting and decrypting data, a method and apparatus for automatically setting up the encryption/decryption system, a method and apparatus for authenticating a second apparatus using the encryption/decryption method, and a pseudo-random number generator used for the encryption/decryption system.

### BACKGROUND OF THE INVENTION

A number of encryption methods are currently used in various fields. Cryptographic systems (cryptosystems) protect data, especially sensitive data, from being hacked, eavesdropped, or stolen by any unintended party. Cryptographic methods are also used for authentication between users, between various computer systems, and between users and the computer systems. Ideally, encryption transforms original input data into encrypted data that is impossible to read or decrypt without the proper key.

Cryptosystems can be classified in several manners, for example, classified into symmetric cryptosystems and asymmetric cryptosystems. Symmetric cryptography is also referred to as secret-key cryptography, which uses a single key (the secret key) to encrypt and decrypt information. Since there is only one key, it requires some form of secure key exchange (in person, by courier, and the like). Asymmetric cryptography is referred to as public-key cryptography, which uses a pair of keys: one (the public key) to encrypt data such as a message, and the other (the private key) to decrypt it.

The Data Encryption Standard (DES) is one of the most well-known encryption algorithms, which is a symmetric algorithm using a single 56-bit key. DES employs a block cipher where the original data (“plaintext”) is divided up into blocks and each block is processed individually in multiple rounds (iterations) to produce encrypted data (“ciphertext”). In stream ciphers, streams of bits are processed, and they are generally faster than the block ciphers.

Other conventional cryptographic algorithms and methods include, for example, cryptographic hash functions which are typically used for digitally signed messages, random number generators, one time pads, triple DES which is a secure form of DES using a 158-bit key, International Data Encryption Algorithm (IDEA) which is a block-mode secret-key encryption algorithm using a 128-bit key, RC4 (widely used symmetric key algorithm), and the like. In addition, Advanced Encryption Standard (AES) provides stronger encryption scheme with alternative three key lengths of 128 bits, 192 bits, or 256 bits.

Typically, code breakers or attackers try to find the right key to exploit a cryptosystem or view sensitive information. Code crackers typically employs as many as hundreds or thousands of computers to try millions of keys until the right key is discovered. This method of trying every possible key in an attempt to decrypt the ciphertext is referred to as the brute force attack. Brute force attacks are often successful if weak keys or passwords are used, while they are difficult if long keys are used and if the keys consist of mixed numbers and characters in a nonsense pattern. A weakness in the system may reduce the number of keys that need to be tried. In addition, there are many other attacks such as analyzing encryption algorithms or finding a specific pattern in the cryptosystem.

Due to the continuous evolution of computer-based technology, security methods that have seemed unbreakable are becoming inadequate, for example, the 56-bit key size of DES is no longer considered secure against brute force attacks. As performance of computers continues improving, there is an increasing necessity for a much more secure data transfer and storage mechanism. Accordingly, it would be desirable to provide, on all levels from Government security to on-line transactions for the individual, a cryptosystem that is practically impossible to crack even though thousands of supercomputers may be used.

### BRIEF DESCRIPTION OF THE INVENTION

An apparatus encrypts/decrypts data. The apparatus includes (a) a first plurality of encryption tables, each of the encryption tables being capable of transforming a data value into an encrypted/decrypted value, the data value corresponding to a unit of the data, the encrypted/decrypted value corresponding to a unit of encrypted/decrypted data, (b) a second plurality of selection tracks, each of the selection tracks including a series of values having a certain pattern, (c) a track mixer coupled to the second plurality of selection tracks, adapted to combine corresponding values of the selection tracks to produce a series of combined values, and (d) an encryption/decryption module coupled to the first plurality of encryption tables and the track mixer, adapted to transform each unit of the data into a unit of encrypted/decrypted data using an encryption table selected for that unit in accordance with a combined value in the series of combined values.

In accordance with one aspect of the invention, the apparatus further includes an identification code unique to the apparatus, and a first database memory containing the first plurality of encryption tables and the second plurality of selection tracks as an encryption/decryption file associated with the identification code. The first database memory may further include, as the encryption/decryption file, a set of setting parameters capable of modifying values of each of the selection tracks and determining a manner of combination of each selection track to other tracks.

In accordance with one aspect of the present invention, the apparatus further includes a second database memory designated to store at least one second encryption/decryption file different from the encryption/decryption file on the first database memory, and the encryption/decryption file on the first memory is adapted to encrypt the second encryption/decryption file for transmission, or to decrypt the second encryption/decryption file which is encrypted.

A method encrypts/decrypts original data into encrypted/decrypted data. The method includes (a) providing a first plurality of encryption tables, each encryption table being capable of transforming a data value into an encrypted/decrypted value, the data value corresponding to a unit of the data, the encrypted/decrypted value corresponding to a unit of encrypted/decrypted data, (b) providing a second plurality of selection tracks, each selection track including a series of values having a certain pattern, (c) combining corresponding values of the selection tracks to produce a series of combined values, (d) selecting an, encryption table for each unit of the data in accordance with a corresponding combined value in the series of combined values, and (e) transforming each unit of the data into a unit of encrypted/decrypted data using the encryption table selected for that unit.

In accordance with one aspect of the present invention, the method further includes (f) selecting the second plurality of source files from among source files stored in a database memory, and (g) producing a series of values from each of the selected source files. The method may further include at least one of (h) modifying each of the series of values using setting parameters, and (i) selecting a mathematical operation to be used to combine the value of each track with other tracks.

An apparatus encrypts/decrypts original data into encrypted/decrypted data. The apparatus includes (a) means for providing a first plurality of encryption tables, each encryption table being capable of transforming a data value into an encrypted/decrypted value, the data value corresponding to a unit of the data, the encrypted/decrypted value corresponding to a unit of encrypted/decrypted data, (b) means for providing a second plurality of selection tracks, each selection track including a series of values having a certain pattern, (c) means for combining corresponding values of the selection tracks to produce a series of combined values, (d) means for selecting an encryption table for each unit of the data in accordance with a corresponding combined value in the series of combined values, and (e) means for transforming each unit of the data into a unit of encrypted/decrypted data using the encryption table selected for that unit.

In accordance with one aspect of the present invention, the apparatus further includes (f) means for selecting the second plurality of source files from among source files stored in a database memory, and (g) means for producing a series of values from each of the selected source files. The apparatus may further include at least one of (h) means for modifying each of the series of values using setting parameters, and (i) means for selecting a mathematical operation to be used to combine the value of each track with other tracks. The apparatus may further include at least one of (j) means for selecting a data length of the unit, and (k) means for synchronizing operation of the means for selecting and the means for transforming.

In accordance with one aspect of the present invention, the first plurality of encryption tables includes first encryption tables adapted to transform the data value into the encrypted/decrypted value, and second encryption tables adapted to transform the data value into the encrypted/decrypted value, each of the second encryption tables being capable of inverse-transforming the encrypted/decrypted value that is encrypted/decrypted by a corresponding first encryption table into an original data value, each of the first encryption tables being capable of inverse-transforming the encrypted/decrypted data value that is encrypted/decrypted by a corresponding second encryption table into an original data value.

In accordance with one aspect of the present invention, each of the first plurality of encryption tables is associated with a tables location address, and the apparatus further includes means for associating the second encryption tables with the tables location address a predetermined amount offset from that of the corresponding first encryption table. The means for selecting an encryption table may include (d1) means for selecting the encryption tables using the series of combined values if the data is to be encrypted, and (d2) means for selecting the encryption tables using the series of combined values with the predetermined offset if the data is to be decrypted. The means for selecting an encryption table may include (d3) means for selecting the encryption tables using the series of combined values if the data is to be transmitted, and (d4) means for selecting the encryption tables using the series of combined values with the predetermined offset if the data is received. Alternatively, the apparatus may include means for providing a one-to-one association between each of the first encryption tables and the corresponding second encryption table.

In accordance with one aspect of the present invention, the apparatus further includes means for associating a combined value in the series with a tables location address, and means for selecting an encryption table associated with the tables location address.

An apparatus and method automatically set up an encryptor/decryptor on a second apparatus that includes an identification code unique to the second apparatus and a setup file associated with the identification code. The setup file is capable of encrypting/decrypting data. The apparatus includes means for receiving the identification code from the second apparatus, means for retrieving the setup file associated with the identification code from a data base memory containing setup files, means for selecting a set of encryption tables from among a plurality of encryption tables, means for selecting a set of selection tracks from among a plurality of selection tracks, each of the selection tracks including a series of values having a certain pattern produced using a source file, means for selecting a set of setting parameters from among a plurality of setting parameters, means for associating the set of encryption tables, the set of selection tracks, and the set of setting parameters with the identification code, means for encrypting the set of encryption tables, the set of selection tracks, and the set of setting parameters using the setup file, and means for transmitting the encrypted set of encryption tables, the encrypted set of selection tracks, and the encrypted set of setting parameters to the second apparatus. The method includes (a) receiving the identification code from the apparatus, (b) retrieving the setup file associated with the identification code from a data base memory containing setup files, (c) selecting a set of encryption tables from among a plurality of encryption tables, (d) selecting a set of selection tracks from among a plurality of selection tracks, each of the selection tracks including a series of values having a certain pattern produced using a source file, (e) selecting a set of setting parameters from among a plurality of setting parameters, (f) associating the set of encryption tables, the set of selection tracks, and the set of setting parameters with the identification code, (g) encrypting the set of encryption tables, the set of selection tracks, and the set of setting parameters using the setup file, and (h) transmitting the encrypted set of encryption tables, the encrypted set of selection tracks, and the encrypted set of setting parameters to the second apparatus.

An apparatus and method authenticate a second apparatus having an identification code unique to the second apparatus and a setup file associated with the identification code, the setup file being capable of encrypting/decrypting data. The apparatus includes means for receiving the identification code from the second apparatus, means for retrieving a setup file associated with the identification code from a data base memory containing setup files, means for generating a sequence of values and transmitting the sequence to the second apparatus, means for encrypting the sequence using the retrieved setup file, means for calculating a first check sum from the encrypted sequence, means for receiving from the second apparatus a second check sum which is calculated at the second apparatus from an encrypted sequence using the setup file thereof, means for determining if the second check sum matches the first check sum, and means for authenticating the second apparatus if the second check sum matches the first check sum. The method includes (a) receiving the identification code from the second apparatus, (b) retrieving a setup file associated with the identification code from a data base memory containing setup files, (c) generating a sequence of values and transmitting the sequence to the second apparatus, (d) encrypting the sequence using the retrieved setup file, (e) calculating a first check sum from the encrypted sequence, (f) receiving from the second apparatus a second check sum which is calculated at the second apparatus from an encrypted sequence using the setup file thereof, (g) determining if the second check sum matches the first check sum, and (h) authenticating the second apparatus if the second check sum matches the first check sum.

One aspect of the present invention provides a program storage device readable by a machine, tangibly embodying a program of instructions executable by the machine to perform a method for encrypting/decrypting original data into encrypted/decrypted data, wherein the method includes (a) providing a first plurality of encryption tables, each encryption table being capable of transforming a data value into an encrypted/decrypted value, the data value corresponding to a unit of the data, the encrypted/decrypted value corresponding to a unit of encrypted/decrypted data, (b) providing a second plurality of selection tracks, each selection track including a series of values having a certain pattern, (c) combining corresponding values of the selection tracks to produce a series of combined values, (d) selecting an encryption table for each unit of the data in accordance with a corresponding combined value in the series of combined values, and (e) transforming each unit of the data into a unit of encrypted/decrypted data using the encryption table selected for that unit.

One aspect of the present invention also provides program storage device readable by a machine, tangibly embodying a program of instructions executable by the machine to perform a method for automatically setting up an encryptor/decryptor on an apparatus, the apparatus including an identification code unique to the apparatus and a setup file associated with the identification code, the setup file being capable of encrypting/decrypting data, wherein the method includes (a) receiving the identification code from the apparatus, (b) retrieving the setup file associated with the identification code from a data base memory containing setup files, (c) selecting a set of encryption tables from among a plurality of encryption tables, (d) selecting a set of selection tracks from among a plurality of selection tracks, each of the selection tracks including a series of values having a certain pattern produced using a source file, (e) selecting a set of setting parameters from among a plurality of setting parameters, (f) associating the set of encryption tables, the set of selection tracks, and the set of setting parameters with the identification code, (g) encrypting the set of encryption tables, the set of selection tracks, and the set of setting parameters using the setup file, and (h) transmitting the encrypted set of encryption tables, the encrypted set of selection tracks, and the encrypted set of setting parameters to the apparatus.

One aspect of the present invention further provides a program storage device readable by a machine, tangibly embodying a program of instructions executable by the machine to perform a method for authenticating an apparatus having an identification code unique to the apparatus and a setup file associated with the identification code, the setup file being capable of encrypting/decrypting data, wherein the method includes (a) receiving the identification code from the apparatus, (b) retrieving a setup file associated with the identification code from a data base memory containing setup files, (c) generating a sequence of values and transmitting the sequence to the apparatus, (d) encrypting the sequence using the retrieved setup file, (e) calculating a first check sum from the encrypted sequence, (f) receiving from the apparatus a second check sum which is calculated at the apparatus from an encrypted sequence using the setup file thereof, (g) determining if the second check sum matches the first check sum, and (h) authenticating the apparatus if the second check sum matches the first check sum.

A pseudo-random number generator includes (a) a selection track generator adapted to generate a plurality of selection tracks, each selection track including a series of values having a certain pattern produced using a corresponding source file, and (b) a track mixer coupled to the selection track generator, adapted to combine corresponding values of the selection tracks to produce a series of combined values. The selection track generator may include a memory storing a plurality of source files, and a track pattern manager coupled to the memory, adapted to generate a series of values from a selected source file. The track pattern manager may further be adapted to modify each of the series of values using setting parameters, and/or to select a mathematical operation to be used to combine the value of each track with other tracks.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a computer system suitable for implementing aspects of the present invention.

FIG. 2 is a diagram schematically illustrating an apparatus for encrypting/decrypting data in accordance with one embodiment of the present invention.

FIG. 3A is a diagram schematically illustrating an example of an encryption table (unitary table) for the unit data size of 8 bit in to explain the structure of the encryption tables, in accordance with one embodiment of the present invention.

FIG. 3B is a diagram schematically illustrating an example of an encryption table for the unit data size of 8 bit used for encryption/decryption, in accordance with one embodiment of the present invention.

FIG. 3C is a diagram schematically illustrating an example of an encryption table for the unit data size of 8 bit used for encryption/decryption, in accordance with one embodiment of the present invention.

FIG. 4A is a diagram showing the raw hexadecimal data of a segment of an audio noise file used as a source file in accordance with one embodiment of the present invention.

FIG. 4B is a diagram showing the raw hexadecimal data of a segment of a gradient graphic file used as a source file in accordance with one embodiment of the present invention.

FIG. 5 is a diagram schematically illustrating an example of the selection tracks where the series of values are graphically represented, in accordance with one embodiment of the present invention.

FIG. 6 is a diagram schematically illustrating an example of a setting screen for the encryption tables and the selection tracks in accordance with one embodiment of the present invention.

FIG. 7 is a diagram schematically illustrating the process of mixing the selection tracks by the track mixer in accordance with one embodiment of the present invention.

FIG. 8 is a diagram schematically illustrating a method for encrypting/decrypting input data into encrypted/decrypted data in accordance with one embodiment of the present invention.

FIG. 9A is a diagram schematically illustrating a process flow of encryption operation in accordance with one embodiment of the present invention.

FIG. 9B is a diagram schematically illustrating a process flow of decryption operation in accordance with one embodiment of the present invention.

FIG. 10 is a diagram schematically illustrating an example of encryption and decryption processes in accordance with one embodiment of the present invention.

FIG. 11A is a diagram schematically illustrating an example of encryption table selection function in a complementary encryption table bank during an encrypting (transmitting) process and a decrypting (receiving) process, in accordance with one embodiment of the present invention.

FIG. 11B is a diagram showing the relationship between encryption tables used in the encrypting (transmitting) process and decrypting (receiving) process (left box), and the relationship between complementary row locations (right box) in the complementary encryption table bank shown in FIG. 11A.

FIG. 12A is a diagram schematically illustrating an example of encryption table selection function in a redirected encryption table bank during an encrypting (transmitting) process and a decrypting (receiving) process, in accordance with one embodiment of the present invention.

FIG. 12B is a diagram showing the relationship between encryption tables used in the encrypting (transmitting) process and the decrypting (receiving) process (left box), and the relationship between redirected row locations (right box) in the redirected encryption table bank shown in FIG. 12A.

FIG. 13 is a diagram schematically illustrating a system for automatically setting up an encryptor/decryptor on an apparatus in accordance with one embodiment of the present invention.

FIG. 14 is a diagram schematically illustrating a back up system for the setup files and session files in accordance with one embodiment of the present invention.

FIG. 15 is a diagram schematically illustrating a method for authenticating an apparatus in accordance with one embodiment of the present invention.

### DETAILED DESCRIPTION

Embodiments of the present invention are described herein in the context of an apparatus and method for encryption and decryption. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Solaris® available from Sun Microsystems, Inc. of Palo Alto, Calif., Microsoft® Windows® XP and Windows® 2000, available form Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

In the context of the present invention, the term “network” includes local area networks (LANs), wide area networks (WANs), the Internet, cable television systems, telephone systems, wireless telecommunications systems, fiber optic networks, ATM networks, frame relay networks, satellite communications systems, and the like. Such networks are well known in the art and consequently are not further described here.

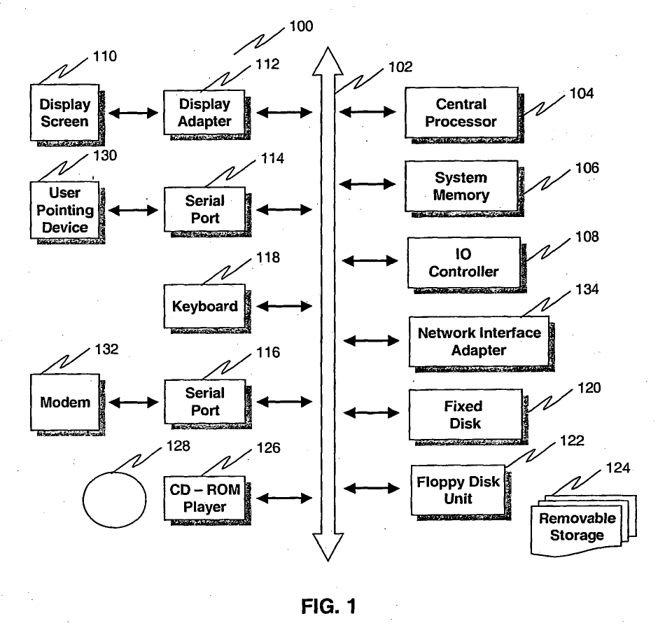

FIG. 1 depicts a block diagram of a computer system 100 suitable for implementing aspects of the present invention. As shown in FIG. 1, computer system 100 includes a bus 102 which interconnects major subsystems such as a central processor 104, a system memory 106 (typically RAM), an input/output (I/O) controller 108, an external device such as a display screen 110 via display adapter 112, serial ports 114 and 116, a keyboard 118, a fixed disk drive 120, a floppy disk drive 122 operative to receive a floppy disk 124, and a CD-ROM player 126 operative to receive a CD-ROM 128. Many other devices can be connected, such as a pointing device 130 (e.g., a mouse) connected via serial port 114 and a modem 132 connected via serial port 116. Modem 132 may provide a direct connection to a remote server via a telephone link or to the Internet via a POP (point of presence). Alternatively, a network interface adapter 134 may be used to interface to a local or wide area network using any network interface system known to those skilled in the art (e.g., Ethernet, XDSL, AppleTalk™).

Many other devices or subsystems (not shown) may be connected in a similar manner. Also, it is not necessary for all of the devices shown in FIG. 1 to be present to practice the present invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion. Code to implement the present invention may be operably disposed in system memory 106 or stored on storage media such as fixed disk 120, floppy disk 124 or CD-ROM 128.

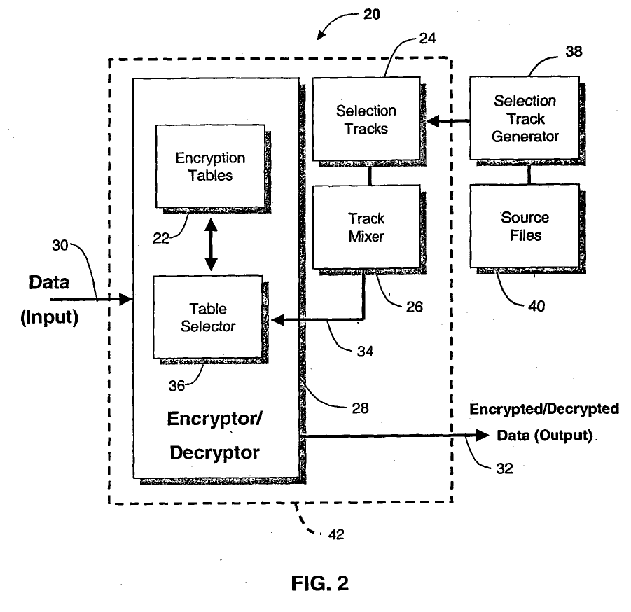

FIG. 2 schematically illustrates an apparatus 20 for encrypting/decrypting data in accordance with one embodiment of the present invention. In this specification, encrypting/decrypting generally means performing encryption and decryption. However, the term also includes cases where only encryption is performed or only decryption is performed. As shown in FIG. 2, the apparatus 20 includes a first plurality of encryption tables 22, a second plurality of selection tracks 24, a track mixer 26, and an encryption/decryption module (encryptor/decryptor) 28. The apparatus 20 is adapted to receive input data 30 and output encrypted/decrypted data 32. If the input data 30 is the original data (or plaintext), the apparatus 20 encrypts the input data 30 and outputs encrypted data (or ciphertext) 32. If the input data 30 is the encrypted data (or ciphertext), the apparatus 20 decrypts the input data 30 and outputs decrypted data (or plaintext) 32.

The input data 30 may be stored in a file on a memory and read into the apparatus 20 for encryption or decryption. The input data 30 may also be a stream of data being transmitted in real time, for example, audio or video data transmitted in a real-time communication. Similarly, the encrypted/decrypted data 32 may be stored in a memory, or being transmitted in a real time communication as a stream of data.

Each of the encryption tables 22 is capable of transforming a data value into an encrypted/decrypted value. The data value corresponds to a unit of the input data 30, and the encrypted/decrypted value corresponds to a unit of the encrypted/decrypted data 32. That is, the apparatus 20 processes the input data 30 by a certain data unit, i.e., a certain number of data bits. For example, four (4), eight (8), or sixteen (16) bits can be used. However, the unit data size can be any size from a single bit to a large string of data bits, for example, for audio or video data files. The apparatus 20 may also include a data step size selector (not shown) to select a bit length for the data unit. The default value may be set as 8 bits (one byte).

Each of the selection tracks 24 includes a series of values having a certain pattern. The track mixer 26 is coupled to the selection tracks 24, and combines corresponding values in the plurality of selection tracks so as to produce a series of combined values 34. The encryption/decryption module 28 is coupled to the encryption tables 22 and the track mixer 26. The encryption/decryption module 28 transforms each unit of the input data 30 into a unit of encrypted/decrypted data 32 using an encryption table selected for that unit in accordance with a combined value in the series of combined values 34.

As shown in FIG. 2, the encryption/decryption module 28 may include a table selector 36, which selects one encryption table from among the encryption tables 22 in accordance with the current combined value in the series of combined values 34. In addition, the apparatus 20 may further include a selection track generator 38 which generates the second plurality of selection tracks 24 from a plurality of source files 40.

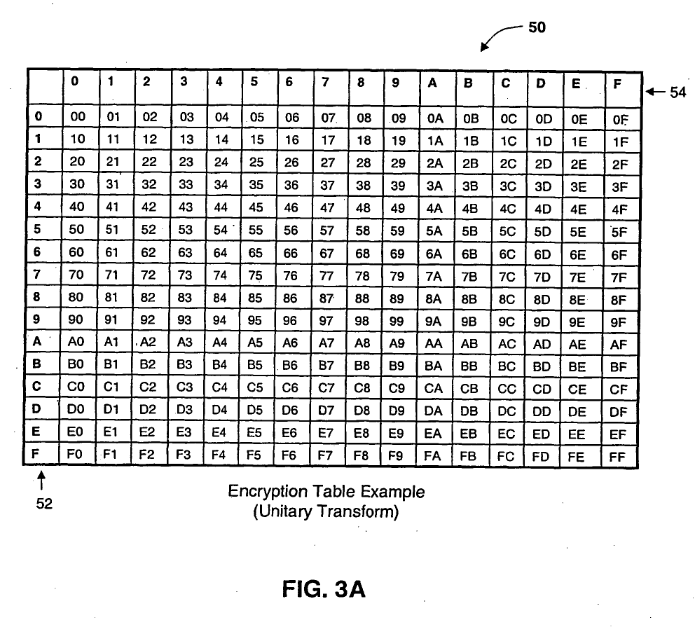

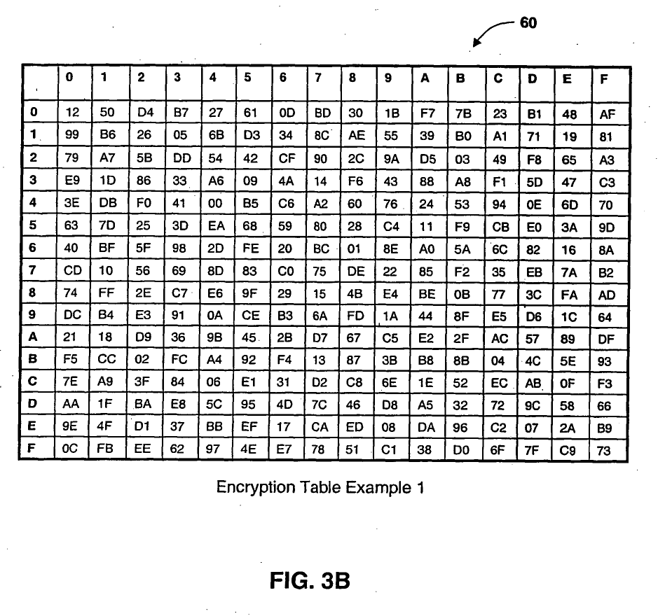

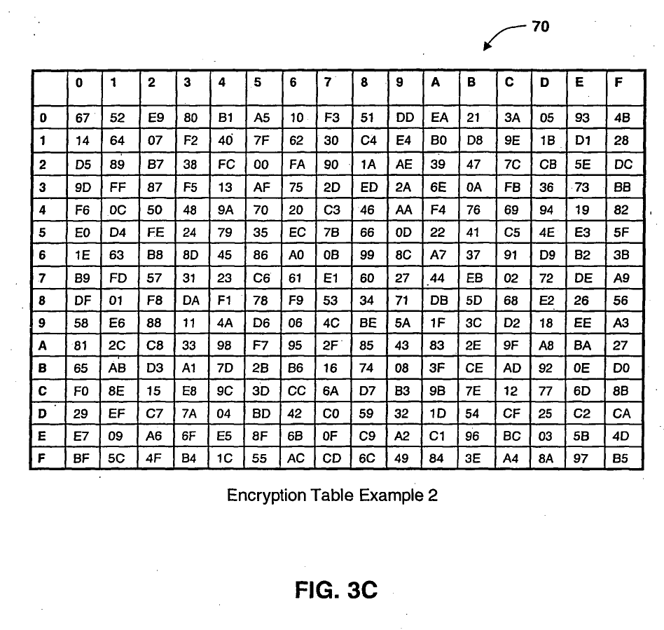

In accordance with one embodiment of the present invention, an encryption table is a data table that contains one instance each of all possible values of the unit data so as to provide one-to-one transformation from a data value into an encrypted/decrypted value. For example, all possible values are represented by a grid of rows and columns, i.e., arranged in a matrix. FIG. 3A illustrates an example of an encryption table (“unitary” encryption table) 50 which is presented in order to explain the structure of the encryption tables. The encryption table 50 transforms each 8-bit data value into that data value itself (unitary transform) and thus is not used for encryption. As shown in FIG. 3A, the row position 52 represents the first nibble (MSB 4 bits), and the column position 54 represents the second nibble (LSB 4 bits) of the one-byte (8-bit) input data. The values are represented in hexadecimal notation (0, 1, . . . , F). A matrix cell specified by the row and column positions contains the encrypted value of the row-column data value. Since the encryption table 50 provides the unitary transform (i.e., no encryption), each cell contains the original data value itself.

FIGS. 3B and 3C illustrate encryption tables 60 and 70, respectively, which actually transform input data values into encrypted/decrypted data values. The matrix cells contain the same set of the possible 256 values (00, 01, . . . , FF), but their positions are shuffled and rearranged in each of the encryption tables. Theoretically, 256! (=256×255×254× . . . ×2×1) encryption tables exist for this one byte transform (including the unitary table). A desired number of encryption tables are selected from among the possible encryption tables so as to form a set of encryption tables. A set or group of the selected encryption tables is referred to as an encryption table bank. Preferably, as many data values as possible are transformed into an encrypted value different from the original data value in each encryption table. It is also preferable that the encryption tables in a encryption table bank are as unique as possible from one another in a similar manner. The encryption tables can be any size. For example, the encryption table bank size may be 256, as described above, or 512, 1024, 2048, 4096, or the like. In addition, the encryption table is not limited to actual table format, but any format can be used so long as one-to-one transformation from the input data values into encrypted values is provided. Furthermore, any number of encryption tables may be included in an encryption table bank, and the encryption table bank size can be customized. The default bank size may be 256 tables.

In accordance with one embodiment of the present invention, each of the encryption tables in an encryption table bank has a tables location address, and an encryption table is specified and/or selected using its tables location address. For example, such a tables location address may be a location in the encryption table bank, or memory address of a specific memory storing the encryption tables. The encryption tables in an encryption table bank may be numbered, and the table number may be used to select the encryption table.

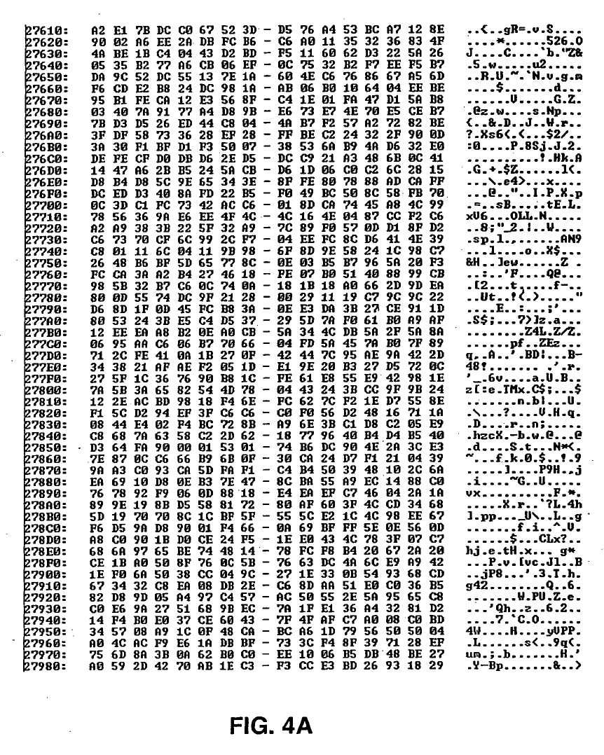

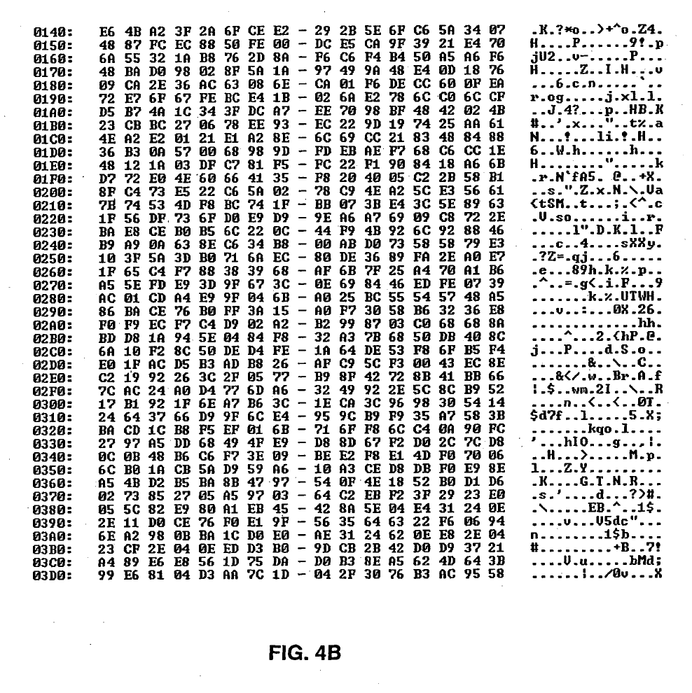

In accordance with one embodiment of the present invention, the selection track generator 38 (FIG. 2) generates the selection tracks as follows. The plurality of source files 40 may be any data or file stored in a memory, and used to produce the selection tracks. The source files 40 include audio files (for example, noise files), graphics files (for example, gradient files), passwords (in any length and any numbers), waveforms and modulation thereof, mathematical functions (for example, periodic functions), waveform lookup tables, and the like. The source files 40 may also include a hardware key such as a universal serial bus (USB) memory device which is plugged in at the time of use. FIGS. 4A and 4B illustrate examples of the source files 40. FIG. 4A shows the raw hexadecimal data of a segment of an audio noise file, and FIG. 4B shows the raw hexadecimal data of a segment of a gradient graphic file. In the both data, on each row the file address is the far left column followed by 16 bytes of data shown in hexadecimal notation. In addition, a selection track may be generated by a pure software module, such as a mathematical modulator or oscillator as a real-time source. Any software module capable of generating a certain pattern can be used, and any synthesizing technique can also be used for any number of selection tracks.

The data contained in the source files are converted into corresponding series of values using a software module, for example, a track pattern manager. Any number of source files can be used to produce a desired number of selection tracks. When the data in the source files is converted into the series of values, the number of bits of each value (mixer step size) can be selected. This number of bits is used in the process of selecting an encryption table for each unit of the input data. For example, in a case where the mixer step size is eight bits and there are three selection tracks, an eight-bit value is taken from each selection tracks, and the three eight-bit values are combined into a combined value. The combined value may exceed eight bits, and may be buffered, if necessary, without clipping. Also, the combined value may be negative since, for example, the mathematical operations to combine the values include subtraction.

In addition, it should be noted that the mixer step size is independent of the unit size of the input data (data step size) by which the input data is encrypted/decrypted. For example, in a case of audio data, the input data may be processed by 32-bit or 64-bit word, and eight bits of each selection track are used (after combined) to select one encryption table for encrypting the 32-bit (or 64-bit) input data. The mixer step size is not limited to eight bits, but any bit number can be used for the mixer step size, for example, 4 bits, 8 bits, 16 bits, and the like. If the mixer step size is n bits, each value in the series of values (selection track values) has n bits, as described above in the 8-bit case.

Before the series of the selection track values are combined, they may be modified using certain setting parameters. The processes of producing the series of values, setting various parameters, and modifying the values according to the setting parameters may be performed real-time (at the same time as encryption/decryption processes), and may also be pre-processed and stored as a data file.

The setting parameters may specify how the series of values are produced from the corresponding source file. For example, such setting parameters include a value offset, a step offset, a loop length, and the like. The value offset is a value added to or subtracted from each of the selection track values. The step offset specifies a stating point of the series of values to be combined with other series of track selection values. For example, if the step offset is set, the series of values does not start at the beginning of the corresponding source file, but at some step point (specified by the step offset) further into the source data. The loop length is the number of process steps at which the corresponding source data is to return to the beginning or to the step offset, if it is greater than zero. If the source data is not as long as the loop length, the loop will begin when the source data reaches its end. In addition, for each of the selection tracks, a mathematical operation, such as addition, subtraction, multiplication, may be set to specify how the values of the selection track are combined with that of other tracks.

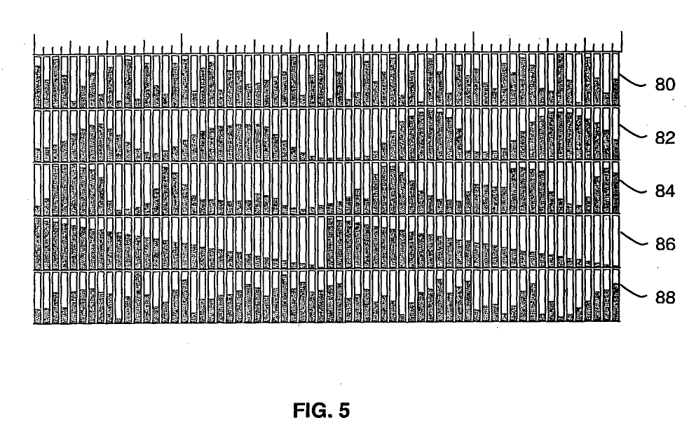

FIG. 5 illustrates an example of selection tracks 80-88 where the series of values are graphically represented in accordance with one embodiment of the present invention. In each selection track, values for 64 process steps are shown, and the height of each bar corresponds to the value. In the selection track 86, the gradient pattern returns to its beginning after the 32nd step (i.e., the loop length 32). Other selection tracks 80-84 and 86 have the loop lengths greater than 64 steps and thus the “loop-back” points are not shown in FIG. 5.

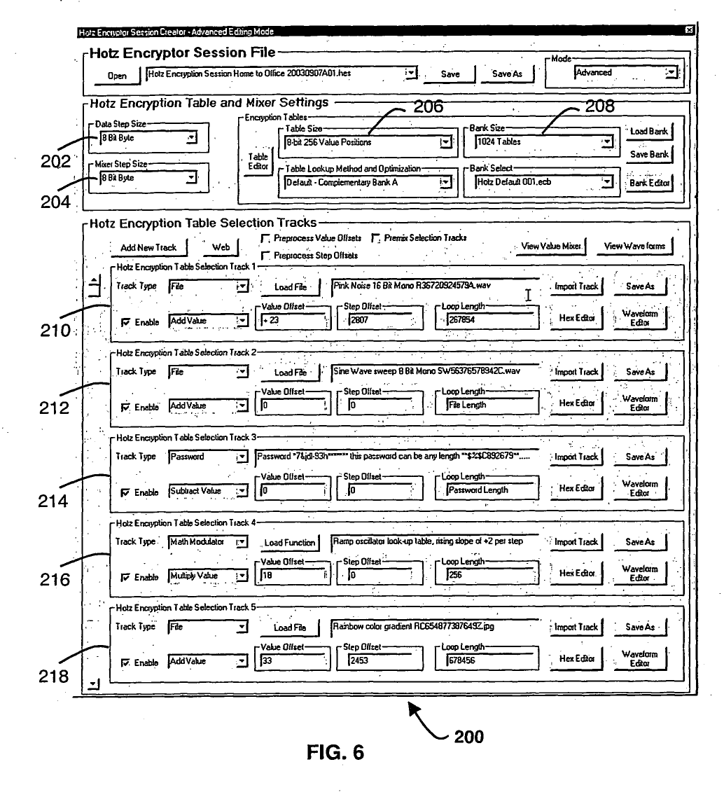

FIG. 6 schematically illustrates an example of a setting screen 200 for the encryption tables and the selection tracks in accordance with one embodiment of the present invention. As shown in FIG. 6, the unit data length for the input data and the encrypted/decrypted data is set as a Data Step Size 202. The data length for the values in the selection tracks is set as Mixer Step Size 204. The setting screen 200 also shows the size of the encryption tables (Table Size 206) and the size of the encryption table bank (Bank Size 208). Five selection tracks 210-218 (Hotz Encryption Table Selection Tracks 1-5) are shown with the source file type (File Type), brief description of the corresponding source file, and setting parameters (Value Offset, Step Offset, Loop Length). For example, the selection tracks 212 is a sine wave which is stored as a data file, and the selection track 216 is generated from a software module (ramp oscillator) in real-time (not from a stored data file). In addition, the manner the selection track is to be combined with others is specified by a mathematical operation, such as “Add Value,” “Subtract Value,” and “Multiply Value.” The setting screen 200 may be used as a user interface for manual setting or editing these components and files for the apparatus 20. However, these settings may be automatically selected from among pools of setting parameters, for example, using any type of pseudo-random value generator. It should be noted that the setting screen 200 and parameter values therein are presented by way of example and is not intended to be exhaustive or limiting in any way.

The track mixer 26 combines one value from each of the selection tracks and produce a combined value for each step for as long as necessary to encrypt/decrypt the input data. A new encryption table selection occurs at each process step, i.e., for each unit length of the input data, and a combined value in the series is used to select one of the encryption tables for the currently-processed unit of the input data. When the next unit of input data is processed, the next combined value in the series is used to select a next encryption table to process this next unit. That is, in this sense, the selection of the encryption tables (table selection step) is synchronized with the encryption/decryption of the input data (data processing step).

The number of possible combined values (i.e., the number of possible table selections) available from the track mixer 26 may be larger than the actual number of encryption tables 22 in the encryption table bank. The number of possible selections can be as large as the number of selection tracks, times (the possible step size values+possible offset values), times any other possible number of mathematical operations used to combine the selection tracks. However, the possible combined values may be wrapped on the encryption table bank size (i.e., the number of the encryption tables) such that any combined value is associated with one of the selection tables. For example, the combined value may be wrapped both in the positive and negative directions to accommodate the actual number of encryption tables in the encryption table bank. If 256 tables are used, for example, utilizing a zero (0) based numbering system (i.e., the encryption table (0) to (255)), then a combined value of (258) would select the encryption table (2) as it wrapped positively, a combined value of (−10) would select the encryption table (246) as it wrapped negatively, a selection value of (512) would select an encryption table (0) as it wrapped positive, and the like. Using the wrapping process, any combined value is associated with one of the encryption tables or the tables location addresses thereof.

More than one encryption table banks can be used, and the encryption table banks can be switched or changed in a synchronized manner in the table selection and encryption/decryption steps, if desired. Such encryption table bank change may be performed automatically in a real-time communication, for example, by time stamping to the synchronized step. Such a bank-changing information can be saved as an automated function that can be used during an encryption/decryption process or can be sent in synchronization with the data stream and transmitted in real time.

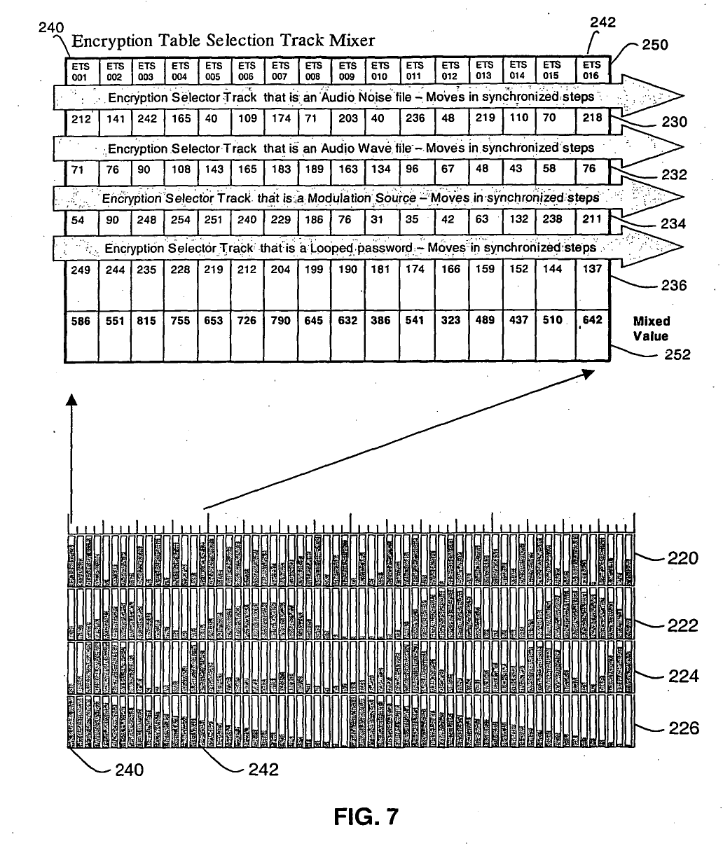

FIG. 7 schematically illustrates the process of mixing or combining the selection tracks by the track mixer 26 in accordance with one embodiment of the present invention. The lower part of FIG. 7 shows, as an illustrative example, selection tracks 220-226 in a graphical representation in a similar manner as FIG. 5. In this example, the selection tracks 220-226 are produced using an audio noise file, an audio wave file, a modulation source, and a looped password, respectively. The upper part of FIG. 7 shows corresponding series 230-236 of actual values of the selection tracks 220-226 for the first sixteen process steps (between a first step 240 and a sixteenth step 242). The first row of the upper part represents encryption table selection steps (ETS) 250.

As shown in FIG. 7, at each step, corresponding values of the selection tracks 230-236 are combined into a combined (mixed) value so as to produce a series of combined values 252. In this example, the combined value is a summation of the corresponding selection track values. If the encryption table bank has 256 encryption tables, some of the combined values exceed the number of the encryption tables. Thus, as described above, such exceeding values are wrapped in the negative or positive. Each encryption table bank may include information on how the table selection wrapping occurs.

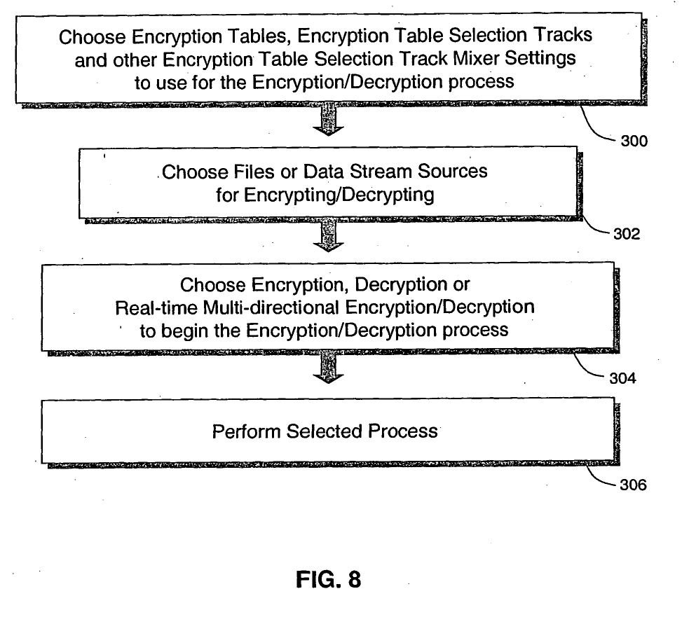

FIG. 8 schematically illustrates a method for encrypting/decrypting input data into encrypted data in accordance with one embodiment of the present invention. First, selections of the encryption tables, selection tracks, and other setting parameters for the selection tracks and the track mixer are made for an encryption/decryption process (300). For example, an encryption/decryption session editor (software tool) such as the setting screen 200 illustrated in FIG. 6 may be used for this selection. Here, an “encryption/decryption session” means an encryption/decryption operation for given input data using a specific set of necessary components (such as encryption table bank, selection tracks) and settings thereof. Next, the input data, for example, certain files or data stream sources to be encrypted/decrypted is selected (302), and also a mode of operation is selected for the encryption/decryption process (304). For example, a process for encryption or decryption, real-time processing, unidirectional, multi or bi-directional transmission is selected. Then, the selected process is performed (306).

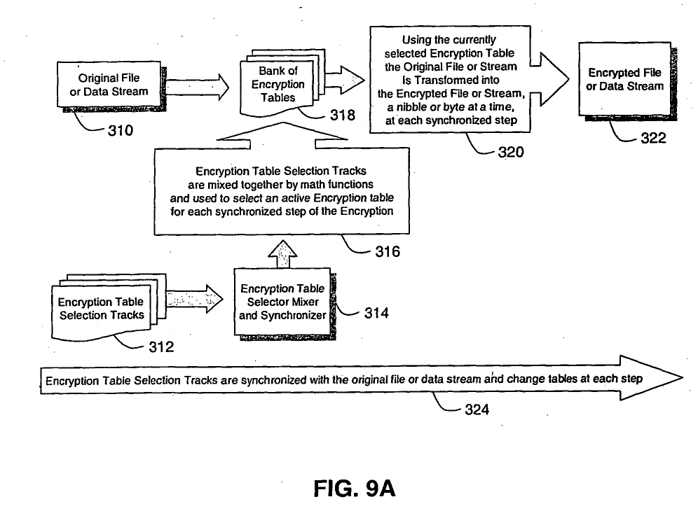

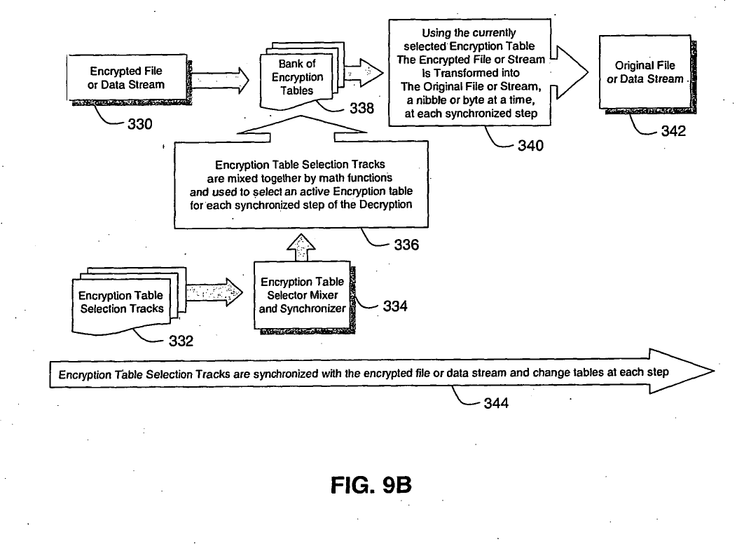

FIG. 9A schematically illustrates a process flow of an encryption operation in accordance with one embodiment of the present invention. This encryption process may be performed using the apparatus 20 described above or any program modules implementing the apparatus 20. In each process step, the unit length of the original data 310 is taken. For example, the original data is read from a file by the unit, or a data stream is received in real-time from a data source (such as an audio/voice message to be transmitted) and taken by the unit. The unit length is, for example, one byte which is parsed by the number of bits specified in the Data Step size (8 bits in this case).

As described above, using the selection tracks 312 and the track mixer 314, a series of combined values are produced and used to select an encryption table from the encryption table bank 318 (316). Using the currently selected encryption table, as described above, the original data is encrypted (320) and the encrypted data 322 is output. During this encryption process, taking the unit of the input data and selecting an encryption table is synchronized and a new encryption table is selected for each unit of the original data (324).

FIG. 9B schematically illustrates a process flow of a decryption operation in accordance with one embodiment of the present invention. This decryption process may be performed using the apparatus 20 described above or any program modules implementing the apparatus 20. In each process step, the unit length of the encrypted data 330 is taken. For example, the encrypted data is read from a file by the unit, or a data stream is received in real-time transmission or communication and taken by the unit. The unit length is, for example, one byte which is parsed by the number of bits specified in the Data Step size (8 bits in this case).

As described above, using the selection tracks 332 and the track mixer 334, a series of combined values are produced and used to select an encryption table from the encryption table bank 338 (336). Using the currently selected encryption table, as described above, the encrypted data is decrypted (340) and the original data 342 is output. In the decryption process, however, the encrypted value is found in a matrix cell of the encryption table, and the corresponding original value is obtained by the row-column position of the cell. That is, in the case of one-byte data size, the row position represents the first nibble of the original data, and the column position represents the second nibble of the original data. Thus, in this embodiment using a basic encryption table bank, the decryption operation requires searching the matrix cells for the encrypted value. However, the encryption table bank can be structured so as to optimize the process speed, as described below. During this decryption process, taking the unit of the encrypted data and selecting an encryption table is synchronized and a new encryption table is selected for each unit of the encrypted data (344).

The encryption process described in FIG. 9A and the decryption process described in FIG. 9B may be performed separately, or simultaneously in a bi-directional communication or transaction.

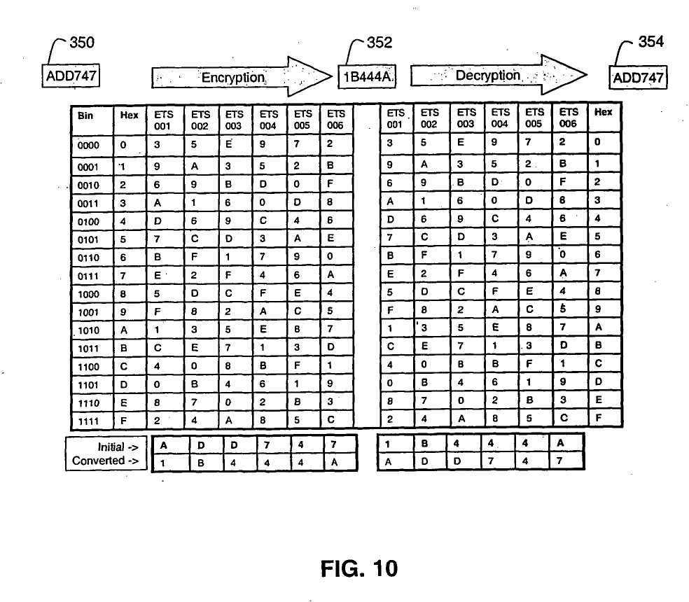

FIG. 10 schematically illustrates an example of encryption and decryption process in accordance with one embodiment of the present invention. In this example, the unit data length (step size) is 4 bits (one nibble). As shown in FIG. 10, the input data is represented in both binary (bin) and hexadecimal (Hex), and the encryption table is presented in a form of a column for each process step (ETS). The original data string (ADD747) 350 is encrypted into an encrypted data string (1B44A) 352. The encrypted data string (1B44A) 352 is decrypted into the original data (ADD747) 354 using the same encryption table as that used in the corresponding encryption step.

As described in the above embodiments, exactly the same encryption table bank are used in both encryption and decryption operations (Basic Encryption Table Bank). However, if the same encryption table bank is used for decryption, the decryption process has a slightly longer process time (though still it is very fast) because of the search for the cell value that matches the encrypted value. Thus, in order to optimize the processing speed using the basic encryption table bank, the encryption/decryption processes are allowed to work in reverse in accordance with one embodiment of the present invention (Reverse option). That is, an encryption process can be performed using the encryption table in the “reverse” manner that is used for the decryption process referring to FIG. 9B (i.e., searching the matrix cell values for the original data value and obtaining the encrypted value from the row-column position), and vice versa. Thus, the faster of either the encrypting apparatus or decrypting apparatus may do the slightly more intense processing that involves the search operation. In a case where certain data is stored in an encrypted format, and a decryption process is necessary when the data is retrieved or read to the same apparatus, this Reverse option may be used to allow the faster retrieval of the data using the Basic Encryption Table Bank.

In accordance with one embodiment of the present invention, the encryption table bank includes two sets of encryption tables which provide an inverse transform (inverse lookups) of each other (Complementary Encryption Table Bank). The encryption table bank includes first encryption tables (first set) and second encryption tables (second set) both adapted to transform the data value into the encrypted/decrypted value. Each of the first encryption table has its counterpart in the second set, and the counterpart second encryption table is capable of reverse-transforming the encrypted/decrypted value that is encrypted/decrypted by the corresponding first encryption table into the original data value. Similarly, each of the first encryption tables are capable of reverse-transforming the encrypted/decrypted data value that is encrypted/decrypted by the corresponding second encryption table into an original data value.

For example, in the encryption table 60 in FIG. 3B, a row-column address (corresponding to the input data value) B5 (hex) has the value of 92 (hex). Thus, its counterpart encryption table has a value of B5 (hex) at the row-column dress 92 (hex) so as to provide an inverse-lookup table. Similarly, a row-column address 4E (hex) of the encryption table 60 has the value of 6D (hex), and thus the counterpart encryption table has a value of 4E (hex) at the row-column address 6D (hex). This type of encryption table bank has many advantages in that the same encryption tables may be used for encryption and decryption in the same manner (without search operation) and the only additional overhead is an offset for the tables location address, which can be applied to either the encryption or decryption process.

Thus, in accordance with this embodiment of the present invention, each of the first and second encryption tables is associated with a tables location address, for example, an encryption table bank location, and the second encryption tables have the tables location addresses a predetermined amount offset from that of the Corresponding first encryption table. This offset is equal to the number of encryption tables in the encryption table bank divided by 2. For example, if there are 256 encryption tables in the encryption table bank, the offset value is 126. Thus, if the original data is encrypted using the encryption table #10 (or tables location address 10 in decimal), the decryption of the data is performed using the encryption table #136 (or tables location address 136 in decimal). This is done by adding the offset value to the tables location address with wrapping (when associating the combined value with the table selection address), i.e., if there are 256 encryption tables in the bank, 128 would be added that address with wrap around back to 1 after 256 (if the encryption tables are numbered as 1-256), or back to 0 after 255 (if the encryption tables are numbered as 0-255).

In the case of a stream of data in a real-time communication (unidirectional or bi-directional), the apparatus on the opposite end would use the opposite offset procedure. That is, for example, if the sender apparatus offsets the encryption table selection in its encryption process, the receiver apparatus does not offset in its decryption process. Similarly, if the sender apparatus does not offset the encryption table selection in its encryption process, the receiver apparatus offsets the encryption table selection in its decryption process. That is, only either one of the communicating apparatuses needs to use the offset.

As mentioned above, in accordance with one embodiment of the present invention, the location of these encryption table sets are arranged in the encryption table bank in such a way that the inverse tables are placed in the second half of the encryption table bank in exact relative location to their non-inverted counterparts in the first half of the encryption table bank. The encryption table locations within this type of encryption table bank is explained using an encryption table bank having 64 locations for simplicity.

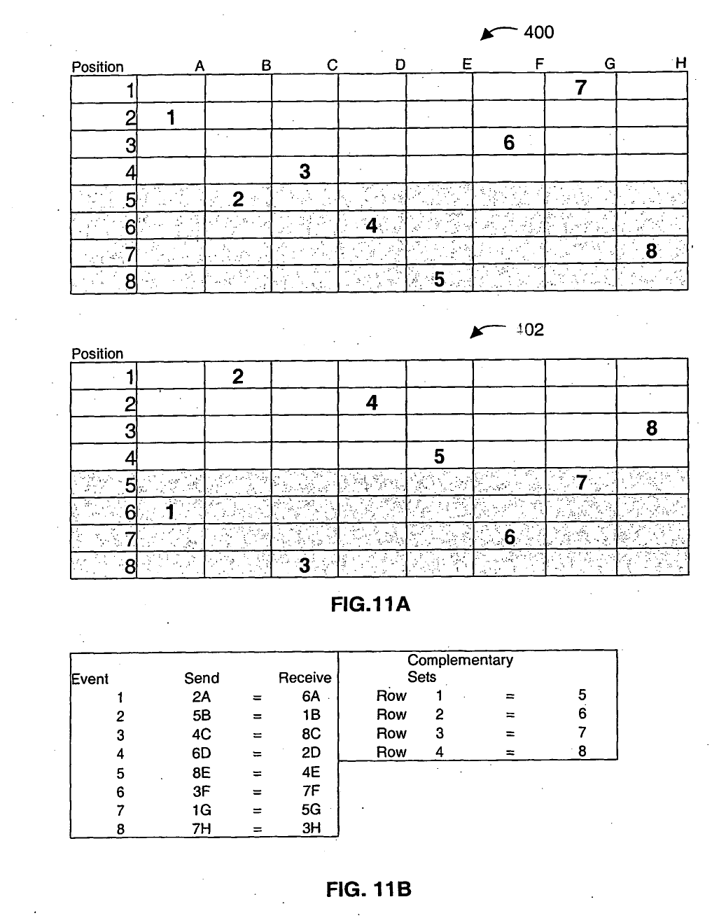

FIG. 11A schematically illustrates an example of encryption table selection function using a complementary encryption table bank during an encrypting (transmitting) operation 400 and a decrypting (receiving) operation 402, in accordance with one embodiment of the present invention. The 64 table locations (1A, 1B, . . . , 8H) are represented by matrix cells at the corresponding row-column address (tables locations address). The encryption tables are identified and selected by their tables location addresses, i.e., the cell locations. The second half (rows 5-8) of the encryption table bank is shaded.

The encryption tables on row 1, columns A-H (i.e., address 1A to 1H) have their inverted counterparts on row 5, columns A-H (i.e., addresses 5A to 5H), respectively. Similarly, the encryption tables on row 2, columns A-H (i.e., address 2A to 2H) have their inverted counterparts on row 6, columns A-H (i.e., addresses 6A to 6H), respectively, the encryption tables on row 3, columns A-H (i.e., address 3A to 3H) have their inverted counterparts on row 7, columns A-H (i.e., addresses 7A to 7H), respectively, and the encryption tables on row 4, columns A-H (i.e., address 4A to 4H) have their inverted counterparts on row 8, columns A-H (i.e., addresses 8A to 8H), respectively.

For example, when a unit of input data is encrypted using the encryption table 2A (the encryption table is being identified by its address) in a sending operation (event 1 in the encryption operation 400), the encrypted data is decrypted using the encryption table 6A in the receiving operation using the same encryption table bank (event 1 in the decryption operation 402). FIG. 11B illustrates the relationship between the encryption tables used in the encryption operation and that in the decryption operation for events 1-8 (left box), and also shows the relationship between the complementary row locations (right box).

Using this type of encryption table bank (Complementary Table Bank) and the table location lookup method, the exactly same bank of encryption tables is used for both encryption and decryption without any searching process in the encryption tables.

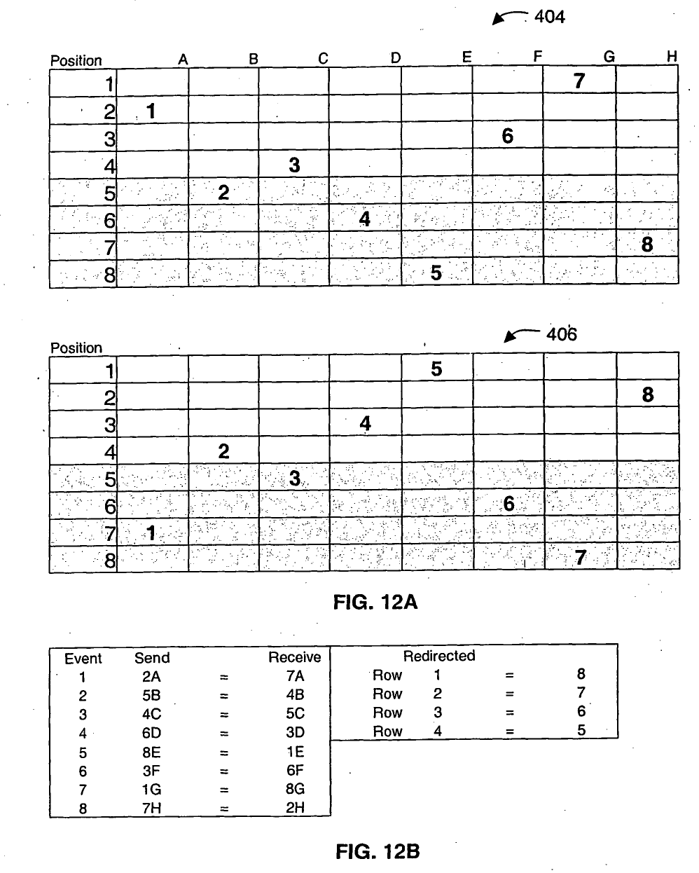

FIGS. 12A and 12B schematically illustrate another embodiment of the present invention similar to that in FIGS. 11A and 11B. In the above embodiment (Complementary Encryption Table Bank) in FIGS. 11A and 11B, the encryption table for decryption process (inverse table) is obtained by a predetermined offset from the encryption table used for the encryption of the data. In this embodiment, the encryption table bank also includes the first encryption tables and the same number of corresponding second encryption tables (i.e., the inverse tables of the first encryption tables). However, the inverse tables can be placed at any location/address of the encryption table bank as long as every encryption table has its counterpart inverse table in the same encryption table bank. This encryption table arrangement also allows the same sets of tables to be on the transmitting/encrypting side and the receiving/decrypting side, but requires two additional lookup tables that are the same size as the encryption tables contained in the encryption table bank. One extra lookup table is used for transmission/encryption process, and the other for receiving/decryption process, and each lookup table provides mapping (or redirection) onto the corresponding inverse table location.

FIG. 12A schematically illustrates a simple example of encryption table selection function using a redirected encryption table bank during an encrypting (transmitting) operation 404 and a decrypting (receiving) operation 406, where the inverse table is located at the same column in a different row (i.e., row redirection). FIG. 12B illustrates the relationship between the encryption tables used in the encryption operation and that in the decryption operation for events 1-8 (left box), and also shows the relationship between the redirected row locations (right box) for the redirected encryption table bank shown in FIG. 12A. In an actual application, locating the inverse table can be single-cell redirections, rather than row redirections. It should also be noted that redirection mapping may be applied to any type of tables and is not limited to tables with inverse lookup sets.

In accordance with one embodiment of the present invention, two sets of the table banks may be provided, one for encryption and the other for decryption. That is, a first encryption table bank includes encryption tables adapted to transform an original data value into an encrypted value, and a second table bank includes encryption tables adapted to transform the encrypted value into the original data value. The first encryption table bank is the full set of the encryption tables, and used for encryption only or for transmitting the encrypted data only. The second encryption table bank is also the full set of inverse table of the first encryption table bank, and the corresponding inverse tables are located at the exactly same address as that of the non-inverse encryption tables in the first encryption table bank. Each inverse table can be obtained from a given encryption table in the same manner as described above. By providing another encryption table bank dedicated for the decryption process, a search process in the decryption side is eliminated, and thus the decryption process is performed as fast as the encryption process. This method allows the fastest lookups but requires that an entire inversion table bank be use when performing the opposite encryption/decryption process.

The type of encryption table bank optimization can also be selected using the setting screen 200 (FIG. 6) described above. In addition, the above-discussed encryption tables and other lookup tables may be converted for digitally signed data (using hash function) or unsigned data to be compatible with the apparatus or software modules implementing the present invention.

In accordance with one embodiment of the present invention, one of more of operations of the track mixer 26, the selection track generator 38, and other operation of setting various parameters may be preprocessed prior to the encryption/decryption operation. Such preprocessing options may be selected in accordance with the application of the present invention. For example, one or more of operations such as selecting the plurality of source files, producing a series of values of each selection track, modifying the selection tack values, selecting a mathematical operation, and combining corresponding values can be preprocessed, and the resulting data can be stored in a memory. In addition, functions such as setting value offsets, step offsets, file segment retrievals may also be preprocessed if desired. Such preprocessing provides even faster encryption/decryption performance.

In accordance with one embodiment of the present invention, the components, files, and other data and information used in encryption/decryption processes can be grouped into various files. For example, a “session file” may include all of the components necessary (and sufficient) to entirely reconstruct one encryption/decryption session. For example, a session file includes the encryption table bank, all selection tracks, and the setting parameters thereof. The session file does not include any of the source files used to produce the selection tracks. However, any setting parameters may be excluded for additional security purposes. A “session, master file” may include all of the components necessary to entirely reconstruct one encryption/decryption session, and any components used in the process. For example, a session master file includes the encryption table bank, all selection tracks and the setting parameters thereof, and all source files. In addition, a “session packet” may include the same components as the session master except any setting parameters that are omitted for additional security. An “encryption table bank” includes a group of encryption tables, for example, 256, 512, 1024, 2048, or 4096 encryption tables. An encryption table bank may also include options for how table selection wrapping occurs, as described above. A “track packet” may include everything necessary to totally reconstruct a set of selection tracks, including any source files, but may have any setting values left empty for additional security purposes. A “single table” includes a single encryption table, for example, a 256 byte array. A “table selector track” is a very small file including all of the values, setting parameters, and data description used to replicate a selection track. During a save operation, some options may be provided to include any or all parts of this data, and optionally any files that are associated with this selection track may be added to a track packet.

In addition, a Hex Editor can be used which displays a file in a hex-editing window for viewing, editing, and saving the edited file if desired. The Hex Editor window displays a file as an address column followed by 16 bytes of hexadecimal (base 16) data and followed by a column to the right which shows the corresponding ASCII character equivalent for that row's 16 bytes of Hex data. The Hex or the ASCII can be edited, if desired, and the edited file is saved. For the graphic representation of the selection tracks, a Waveform Editor may also be used. The Waveform editor displays a file (selection tracks) in a graphical waveform window for viewing, editing, and saving the edited file, if desired. The address (process step) of the file is the horizontal axis. The lower address is to the left and the higher address is to the right. The value of each step of data is shown on the vertical axis. The lower value is at the bottom, while the higher value is at the top. Step sizes can be 8 bits, 16 bits, 24 bits, 32 bits, or the like. Typically 8 or 16 bits is used. The file may be edited with a number of drawing tools if desired and the edited file is saved.

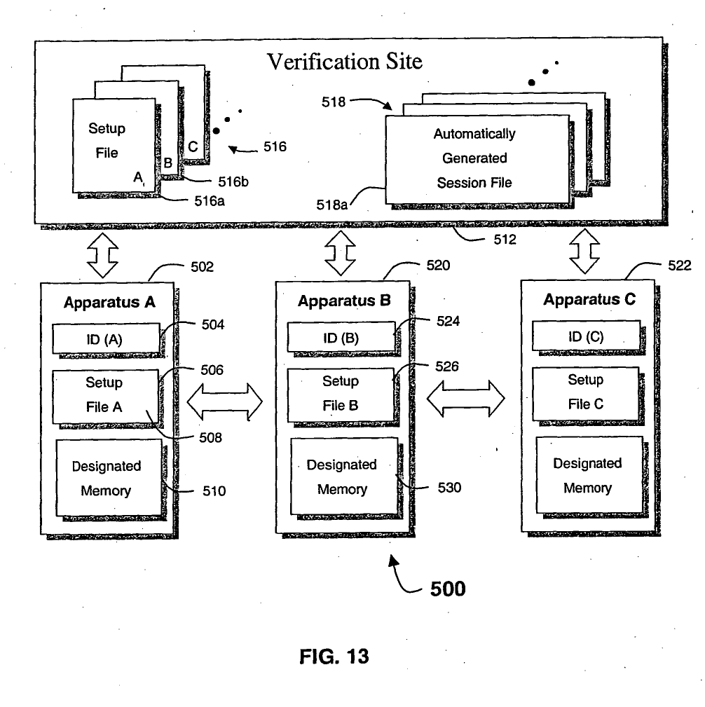

FIG. 13 schematically illustrates a system 500 for automatically setting up an encryptor/decryptor on an apparatus 502 in accordance with one embodiment of the present invention. The system 500 may be cellular phone system, wireless or wired local area network (LAN), shared file sever system (downloading and/or uploading files), live broadcasting system, voice over IP, and any system employing real-time data transfer. The apparatus 502 is capable of encrypting/decrypting data. As shown in FIG. 13, the apparatus 502 includes an identification code 504 unique to the apparatus, and a first database memory 506 containing an encryption/decryption file (setup file) 508 associated with the identification code. The apparatus 502 may also include a second database memory 510 designated to store at least one second encryption/decryption file (session file) different from the encryption/decryption file (setup file) on the first database memory 506.

The identification code 504 is capable of associating a particular physical device or virtual device (created within software) or program module with a specific set of encryption/decryption files. The identification code can be made a part of and associated with any device (physical or virtual) that can respond to or interact with digital data. The apparatus 502 includes, but is not limited to, cellular phones and other communication devices, credit cards, external storage devices, plug-in devices such as universal standard bus (USB) devices, firewall devices, complete computer systems, video game consoles, entertainment boxes, handheld devices, software module or individual program residing on a computer, and the like.

The setup file 508 includes a first plurality of encryption tables (encryption table bank) and a second plurality of selection tracks. Similarly to the above-described embodiments, each of the encryption tables is capable of transforming a data value into an encrypted/decrypted value. The data value corresponds to a unit of the data, and the encrypted/decrypted value corresponds to a unit of encrypted/decrypted data. Any of encryption table banks described above may be used for the setup file. Each of the selection tracks includes a series of values having a certain pattern. The setup file 508 may further includes a set of setting parameters capable of modifying values of each of the selection tracks and determining a manner of combination of each selection track to other tracks.

The apparatus 502 also includes a track mixer module and an encryption/decryption module (not shown). The track mixer module is coupled to the first database memory 506 (and to the second database memory 510), and adapted to combine corresponding values of the selection tracks to produce a series of combined values in accordance with the parameters. The encryption/decryption module is coupled to the first database memory 506 (and to the second database memory 510), and the track mixer module, and is adapted to transform each unit of the data into a unit of encrypted/decrypted data using an encryption table selected for that unit in accordance with a combined value in the series of combined values.

The setup file 508 is adapted to encrypt another encryption/decryption file (session file) for transmission, or decrypt another encryption/decryption file which is received in an encrypted format. Typically, the setup file 508 contains the same elements and data types as a session file, and is typically used for authentication and securely transmitting other sets of session files. On an apparatus with a very small memory, the setup file 508 may even serve as the session file. In this case, the apparatus may not have a memory space for the second memory 510. An apparatus with a larger memory may maintain a plurality of session files.

It should be noted that the identification code 504 itself may be generated using selection tracks and the track mixer. Thus, the apparatus 502 may includes a set of small amounts of data (selection tracks and/or setting parameters) for this purpose instead of containing the identification code 504 as is. The selection tracks and/or setting parameters for the identification code 504 may be part of the setup file 508, or may be a set of data separate from the setup file 508. In this manner, the identification code 504 of any desired length (can be very long) can be generated from a set of small amounts of data (selection tracks).

Using the identification code 504 and the setup file 508 associate therewith, an encryptor/decryptor is automatically set on the apparatus 502 from a verification site 512 as follows. The verification site 512 may be a server or main computer capable of communicating with the apparatus 502 via a computer network (locally or remotely), via Internet, via wireless communications, or the like. The verification site 512 maintains setup files 516 for a plurality of apparatuses that would communicate with the verification site 512, including the apparatus 502 and other apparatuses, for example, apparatuses 520 and 522. The setup files 516 are associated with the identification codes of the corresponding apparatuses.

In automatic setup process, the verification site 512 first receives the identification code 504, for example, from the apparatus 502. A setup file 516a which is associated with the identification code 504 is retrieved from a database memory containing the setup files 516. The setup file 516a is identical with the setup file 508. The verification site 512 automatically creates (assembles) a session file for the apparatus 502 using, for example, a pseudo-random number generator. For example, a set of encryption tables are selected from among a plurality of encryption tables (or from a mother set of encryption tables) so as to assemble an encryption table bank for the apparatus 502. In selecting the encryption tables, the source files 40, the selection track generator 38, and the track mixer described above (in the apparatus 20 in FIG. 2) may be used as a pseudo-random number generator. The ready-made selection tracks 24 and the track mixer 26 may also be used as a pseudo-random number generator. The same method of selecting encryption tables based on a series of combined values can be used to create a subset of the encryption tables.

Also, a set of selection tracks are selected from among a plurality of selection tracks. A mother set of the selection tracks may be already stored in a database. Otherwise, a set of selection tracks may be newly generated using the selection track generator 38, by selecting source files 40 and setting parameters for each track in a similar manner as that of selecting encryption tables. The source files may be obtained from libraries of files, passwords, offsets, tables, and other data. In addition, a set of setting parameters for the selected selection tracks are also selected from a corresponding mother set of parameters in a similar manner. It should be noted that these selection processes may be done using a pseudo-random number generator, as described above, or using a specialized tool (software module) capable of performing such selection processes.

The selected sets of the encryption tables, the selection tracks, and the setting parameters form an automatically generated session file 518a. The session file 518a is then encrypted using the setup file 516a, and transmitted to the apparatus 502. The session file 518a is also stored in the verification site 512 with association with the identification code 504.

The apparatus 502 receives the encrypted session file 518a, decrypts it using the setup file 508, and stores it in the second data base memory 510 which is designated for storing such session file(s).

In accordance with one embodiment of the present invention, some components that the apparatus 502 already has may be used as part of the session file 518a. For example, since the apparatus 502 has the setup file 508 which includes the same type of components and/or files as that of the session file, all or some of the components and/or files can also be used as part of the session file. In this case, when the verification site 512 creates the session file 518a, it also selects components from among that of setup file 516a. For example, the session file 518a may use all or some of selection tracks of the setup file 516a (i.e., 508) and one or more additional selection tracks. In this manner, only additional selection tracks and indication of which selection tracks to be used are encrypted and sent to the apparatus 502 as information on the session file 518a. The information on the session file 518a may include indication of which encryption tables of the setup file to be used (may be the entire encryption table bank) and the new set of the selection tracks, indication of using the existing selection tracks and a new set of setting parameters, indication of which selection tracks and setting parameters are to be used and a new set of encryption tables, or any combination of those. In this embodiment, the apparatus 502 does not have to store the entire new components of the session file 518a, but it can utilize components that may already exist on the system.

Other apparatuses 520, 522, and the like can be setup in the same manner as the apparatus 502. In the case where one apparatus 502 wants to communicate with another apparatus 520 in a se cure manner, they can do so via the verification site 512. For example, the apparatus 502 initiates the communication with the verification site 512 using its identifier code 504, as described above, and also requests for secure communication with the apparatus 520. The verification site 512 creates a session file 518a for the apparatus 502, and securely sends it to the apparatus 502 using the setup file 516a, as described above. The verification site 512 also retrieves the setup file 516b associated with the apparatus 520 (i.e., its identification code 524), encrypts the session file 518a using the setup file 516b, and sends it to the apparatus 520. Since the setup file 526 in the apparatus 520 is identical to the setup file 516b, the apparatus 520 successfully receives and decrypts the encrypted session file 518a to use for the secure communication with the apparatus 502. In this manner, although the apparatus 502 and the apparatus 520 have different setup files, they can have the same session files 518a with which they can securely communicate.

If the designated memory 510 is large enough, the apparatus 502 may maintain the session file 518ato communicate with the apparatus 520, and another session file similarly created by verification site 512 to communicate with another apparatus 522, for example. In the case of cellular phones, such session files may be stored with an association with the call numbers.

In a case where an apparatus, for example, the apparatus 522 has a memory and computing power sufficient to create a session file, the apparatus 522 can operate in the same manner as the verification site 512, and the apparatus 502 can directly communicate with the apparatus 522 for a secure communication.

In accordance with this embodiment, using the identifier code and a particular setup file associated therewith, one or more additional session files are securely transmitted from remote locations. Even on systems that require legacy support of methods such as the AES, the transmission of secure key codes to that system can be achieved by utilizing the encryption/decryption method described above.

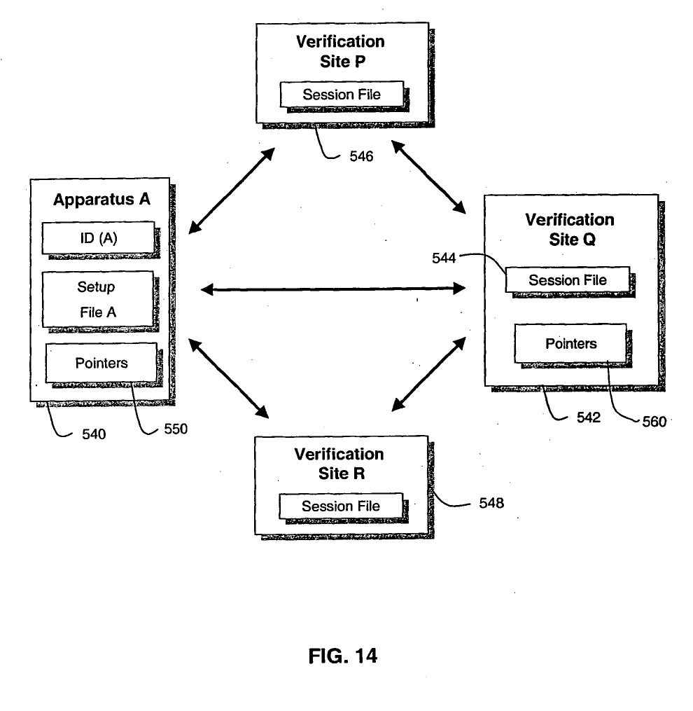

FIG. 14 schematically illustrates a backup system for the setup files and session files in accordance with one embodiment of the present invention. Various components and data that make up a session file associated with a specific identification code may be stored at any number of verification sites as a redundant layer of protection. For example, as shown in FIG. 14, when a verification site 542 creates a session file 544 for an apparatus 540, the entire session file 544 may be stored locally at the verification site 542. In addition, the entire session file 544 or part of it may also be stored at one or more other verification sites 546 and 548. For example, setting parameters for the selection track (selection track data) may be stored at one or more different verification sites, and the original verification site 542 stores pointers 560 to the other verification sites in place of the selection track data. In addition, for additional security, the apparatus 540 may receive or maintain a session file without the selection track data, and obtain the selection track data when necessary. The selection track data may be obtained from the original verification site 542, from other verification site through the original verification site 542, or directly from the other verification site(s). These verification sites are accessible form the apparatus 540 for example, via a computer network, wireless communications, the Internet, or the like. As shown in FIG. 14, the apparatus 540 may have pointers 550 directing to the verification site that stores the necessary file or data.

In accordance with one embodiment of the present invention, no single verification site maintains the entire session file 544, but the session file 544 is divided and distributed among several verification sites, for example, the verification sites 542, 546, and 548. For example, the selection tracks can be distributed such that the first selection track is stored in the verification site 542, the second selection track is stored in the verification site 546, the third selection track is stored in the verification site 548, the fourth selection track is stored in the verification site 542, and the like. Any other components or files, such as the encryption table bank, setting parameters, source files, can be distributed in a similar manner, or may be stored in different verification sites by component. In addition, by utilizing some rotational distribution scheme as described above, such distributed back-up files may be automatically created for the session file 544. In accordance with this embodiment, since one of the verification sites does not have the complete session file, even if one verification site is attacked (virtually or physically) and its information is stolen, the attacker is not able to reconstruct the session file to break the code. Additionally, when dividing and distributing the session file, each component of the session file may be maintained in multiple locations to provide redundancy, in case where, for example, one of the verification sites becomes unavailable for some reason.

In addition, in accordance with one embodiment of the present invention, the various selection tracks may be stored as part of the inventory of an online virtual character or characters. Thus, assembling the entire set of the selection tracks requires each character to meet in the virtual space to place its components onto the track mixer and produce the correct series of combined values which operate as the encryption/decryption key. This process provides a type of group security measure.

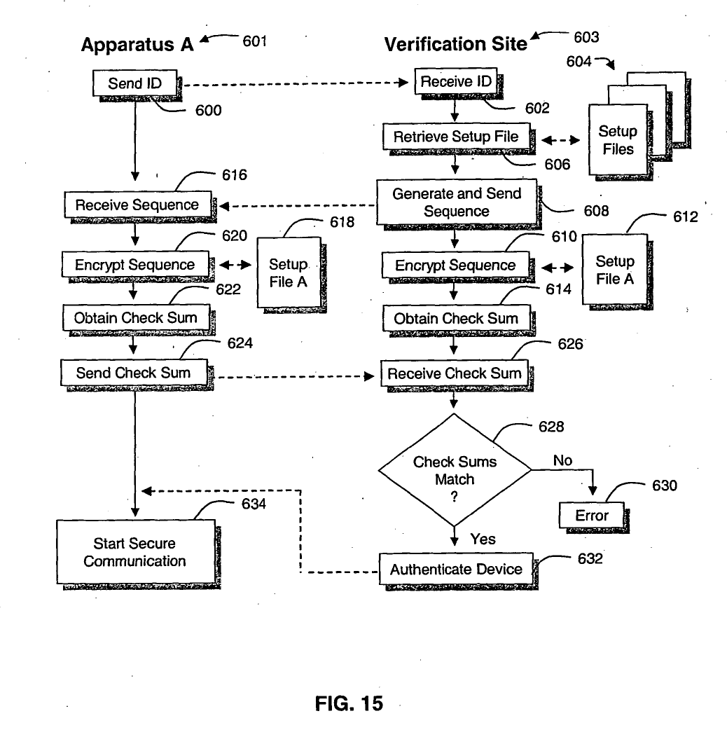

FIG. 15 schematically illustrates a method for authenticating an apparatus 601 in accordance with one embodiment of the present invention. The apparatus 601 to be authenticated is, for example, the apparatus 502 as described in the previous embodiment, and includes cellular phones and other communication devices, credit cards, external storage devices, plug-in devices such as universal standard bus (USB) devices, firewall devices, complete computer systems, video game consoles, entertainment boxes, handheld devices, and the like. The apparatus 601 has an identification code unique to the apparatus and a setup file 618 associated with the identification code, as described above.

As shown in FIG. 15, the apparatus 601 to be authenticated sends its identification code to the verification site 603 (600). The verification site 603 receives the identification code from the apparatus 601 (602), retrieves a setup file associated with the identification code from a data base memory containing setup files 604 (606). The verification site 603 generates a sequence of values, and transmits the sequence to the apparatus 601 (608). The sequence may be an arbitrary or pseudo-randomly selected string of data. At the verification site 603, the sequence is encrypted (610) using the retrieved setup file 612, and a first check sum is calculated from the encrypted sequence (614). For example, the first check sum is obtained by adding each byte of the encrypted sequence. However, the check sum can be obtained using any mathematical functions, and also more than one check sum can be used.

The apparatus 601 receives the sequence (616) and encrypts the sequence using its own setup file 618 (620). The setup file 618 and the setup file 612 are both associated with the same identification code and thus identical. The apparatus 601 also calculates a check sum (a second check sum) in the same manner as the verification site (622), and sends it back to the verification site (624).

The verification site 603 receives the check sum from the apparatus 601 (626), and determines whether the received check sum matches the calculated check sum (628). If the two check sums do not match, the apparatus 601 fails the authentication and an error message may be sent (630). If the two check sums match, the verification site 603 authenticates the apparatus 601 (632), and secure communication or transaction is started (634). As described above, any number of check sums, which can be derived using any mathematical function, can be used to provide redundant and more secure verification and authentication process.

This authentication method can be used in various systems such as the system 500 described above. In accordance with this embodiment, since a specific identification code is used, sensitive information such as an account number or password is not transferred over phone lines, the Internet, or other communication channel. Thus, the embodiment of the present invention provides more secure transactions.

In transactions such as credit card transactions or banking transactions, for example, the identifier code may be a merchant identifier code or a customer identifier code. In a banking or credit card transaction, a merchant (bank) identifier code may exist on a local bank machine, and the customer's identifier code may be stored on the customer's credit card along with the customer's account number. When the card is swiped, both of the account number and the identifier code could be read using a local encryption device on the bank machine. However, only the identifier code is sent to the other party (or verification site such as a main computer or server of the bank). In the verification site, the actual account number of the customer may be retrieved using the identifier code and used as a source file to create one of the selection tracks described above. Additionally, a PIN or password of the customer (associated with the identifier code) may also be used to create another selection track at the verification site (which is also the selection track of the original setup file for the credit card). In this manner, the setup file of the specific customer may be retrieved, or reconstructed, to use in the encryption process. In a case where the apparatus (such as a credit card in this example) has a very small memory, the setup file can be used as a session file as mentioned above. In any case, only the checksum will be sent back to the apparatus to confirm the transaction.

In accordance with one embodiment of the present invention, each of the selection tracks has a key length by which the certain pattern of the track recurs. Preferably, the key length of a selection track is different from the key length of another selection track, or at least one key length is different from another. In accordance with one embodiment of the present invention, none of the key length is obtained by multiplying another key length by 2ⁿ, or by dividing another key length by 2ⁿ, where n is an integer. In accordance with one embodiment of the present invention, differences among the key lengths are substantially smaller than the key lengths. That is, the selection tracks have similar (close) key lengths, and the differences among them are relatively small, for example, such as key lengths of 999, 1000, and 1001. These key lengths also satisfy the above-condition of not being obtained by multiplying another key length by 2ⁿ, or by dividing another key length by 2ⁿ. Typically, the key lengths are selected such that all selection tracks have different key length. However, an extra selection track having the same key length or a relatively small key length may be added for further mixing of the selection tracks.

In accordance with one embodiment of the present invention, by combining a plurality of data streams each of which is an indefinitely repeating small data segment of a different length (i.e., the key length by which the respective data pattern recurs or loops is not equal to one another) and also is not division or squares of each other, as mentioned above, an extremely large unique data stream can be produced. The unique data stream does not repeat itself until the point at which all of the individual data segments return to their beginnings, and this point provides an extremely long key length (derived key length). Thus, this encryption method makes a brute force attack or discovering the derived key impossible.

As described above, the series of combined values to select encryption tables are produced from several selection tracks that are generated small source files such as password or some audio noise file. However, in reality, any size of files can be used. In the following example and formula, it is assumed that none of the key length is obtained by multiplying another key length by 2ⁿ, or by dividing another key length by 2ⁿ (in other words, there are no octave rations between the key lengths), and the results will be compared to the number of possible keys obtained using the AES technique.

The loop-back point (in bit) of the series of combined values produced by mixing the selection tracks of dissimilar key lengths is derived by multiplying the key length of each track in bytes, with the key length of each other track in bytes (for each track), then multiplying by 8 (the number of bits in each byte). The result represents the number (N) of bits that make up the series of combined values before it repeats itself. Thus, the number of possible combinations of the derived key is given as 2^{N}.

### EXAMPLE 1

Three selection tracks with the key lengths of 20,000 byte, 19,999 byte, and 19,998 byte produce the derived key length of N=(20,0000)×(19,999)×(19,998)×8=63,990,400,320,000. Thus, there are 2^{63,990,400,320,000} possible combinations for the derived key. In addition, in order for an attacker to know the derived key length N itself, the attacker would have to know all of the key lengths of the individual selection tracks, and must go through the trillions of combinations of the possible key lengths, and then the zillions of possible key combinations for each of these possible key lengths.

### EXAMPLE 2

Four selection tracks with key lengths of 40,000 byte, 26,680 byte, 39,875 byte, and 47,860 byte yields the derived key length of N=(40,000)×(26,680)×(39,875)×(47,860)×8=16,293,305,248,000,000,000. Thus, the number of possible combinations is 2^{16,293,305,248,000,000,000}.

### EXAMPLE 3

Even smaller selection tracks with key lengths of 1,000 byte, 992 byte, 975 byte, and 832 byte result in the derived key length of N=(1,000)×(992)×(975)×(832)×8=6,437,683,200,000. Thus, the number of possible combination for the derived key is 2^{6,437,683,200,000}.

It should be noted that if an extra selection track having a key length equal to one of the existing selection tracks, for example, adding a fifth track having the key length of 1,000 byte in Example 3, this addition does not increase the number of possible combinations, since the same key length does not change the “loop-back point” in the series of combined values. However, although adding an extra selection tracks of the equal key length or division of another does not increase the protection against a brute force attack, such addition is still useful as a password protection or additional security component, since it adds a value that must be present in the mixed selection track values (i.e. the series of combined values) in order to decrypt the data, and thus adds an additional layer of protection.

It should also be noted that these numbers and key lengths used in the examples are by way of example and are not intended to be exhaustive or limiting in any way. However, it is preferable to use at least three selection tracks having dissimilar key lengths.

By comparing with the AES, the strength of the encryption/decryption system in accordance with one embodiment of the present invention will be well understood. The AES employs three key lengths: 128, 192 and 256 bits. The numbers of possible combination of the key are only: 2¹²⁸, 2¹⁹², and 2²⁵⁶, respectively. In decimal terms, these numbers are approximately: 2¹²⁸≈3.4×10³⁸ for 128-bit keys; 2¹⁹²≈6.2×10⁵⁷ for 192-bit keys; and 2²⁵⁶≈1.1×10⁷⁷ for 256-bit keys. In comparison, DES keys are 56 bits long, which means there are approximately 7.2×10¹⁶ possible DES keys.

By comparing the number of the power of 2 in the number of possible key combinations in accordance with the present invention with that of the AES, one of ordinary skill in the art understands that the cryptosystem in accordance with the present invention is virtually unbreakable by any brute force attack. In addition, the encryption table can be changed for each new unit of data, which may be one byte, or a series of byte, or a nibble or less.

Furthermore, it should be noted that in order to break (by other than a brute force) the code encrypted by the cryptosystem in accordance with the present invention, the attacker must have all of the components and parameters to reconstruct the session file. These components and parameters are not necessarily stored in the same place, as described above, and some of the components and parameters are pre-installed in apparatuses or devices and not transmitted via a communication channel. In addition, such components and parameters can be transmitted separately (individually or by groups), if necessary, or can be distributed among a plurality of virtual or real entities or parties such that only when all of the parties provide their components the encrypted information can be decrypted. Furthermore, any number of parties can share the same encryption/decryption scheme (i.e., the same session file).

Also, data can remain encrypted when stored in a memory or any storage device, and easily decrypted when it is read or used. For example, when reading encrypted data from a storage device, all of the components and parameters for encryption/decryption process can be started by entering necessary data or information through a password-type screen, and the encryption/decryption process remains active during the session, until a user defined event such as log-off, time expiration, or close command occurs.

In addition, a system clock, for example, date information such as year, month, day, hour, and minute (for example, 20030727) can be used as a selection track to create a time limited key. All or any part of the system clock data (month and day, hour only, or the like) can be used to generate a selection track. This value can be preset manually or automatically, and may have a math function (such as a multiplier) applied thereto. For example, when the date data of a system clock is used as a selection track, the data encrypted on a certain date is only decrypted on the same date, since the decryption operation also uses the system clock which is changing (provided system clocks are synchronized). If the preset date is used for encryption, the decryption is only possible on that preset date. Similarly, if the time stamp including certain date and hour (24-hour system) is used as a selection track, the encrypted data is only readable during one specific hour of the day. In this manner, any sensitive information can be made readable or decodable during a limited and/or specified period of time. Furthermore, any type of counter may also be used as a selection track. For example, if MSB of a counter is used as a selection track, the key is valid only during the limited times of event which the counter is counting, for example, the number of the access to the same encrypted file, the number of encryption/decryption sessions, and the like.

In addition, since any length of data (literally megabytes of data) can be produced from several small amounts of data (i.e., selection tracks) each having a certain key length, as described above, when a specific combination of selection tracks and setting parameters generates particular data, this encryption method can be used as a data compression method.

In addition, the present invention can be used as part of a firewall system and/or electronic mail filtering system by allowing data which had been encrypted/decrypted in accordance with the present invention to pass through the firewall or filter. Watermarking or digital signature can also incorporated in the session files and encrypted output files.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. An apparatus for encrypting/decrypting data, said apparatus comprising:
a first plurality of encryption tables, each of the encryption tables being capable of transforming a data value into an encrypted/decrypted value, the data value corresponding to a unit of the data, the encrypted/decrypted value corresponding to a unit of encrypted/decrypted data;
a second plurality of selection tracks, each of the selection tracks including a series of values having a certain pattern;
a track mixer coupled to said second plurality of selection tracks, adapted to combine corresponding values of the selection tracks to produce a series of combined values; and
an encryption/decryption module coupled to said first plurality of encryption tables and said track mixer, adapted to transform each unit of the data into a unit of encrypted/decrypted data using an encryption table selected for that unit in accordance with a combined value in the series of combined values.

2. The apparatus in accordance with claim 1, further comprising:
a selection track generator adapted to generate the second plurality of selection tracks from a plurality of source files.

3. The apparatus in accordance with claim 1, further comprising:
a data step size selector adapted to select a data length for the unit.

4-6. (canceled)

7. The apparatus in accordance with claim 1 wherein operations of said table selector and said encryption/decryption module are synchronized so as to encrypt/decrypt a stream of data transmitted in real time.

8-9. (canceled)

10. The apparatus in accordance with claim 1 wherein said first plurality of encryption tables include:
a first table bank including encryption tables adapted to transform an original data value into an encrypted value; and
a second table bank including encryption tables adapted to transform the encrypted value into the original data value.

11. The apparatus in accordance with claim 1 wherein said first plurality of encryption tables include:
first encryption tables adapted to transform the data value into the encrypted/decrypted value; and
second encryption tables adapted to transform the data value into the encrypted/decrypted value, each of the second encryption tables being capable of inverse-transforming the encrypted/decrypted value that is encrypted/decrypted by a corresponding first encryption table into an original data value, each of the first encryption tables being capable of inverse-transforming the encrypted/decrypted data value that is encrypted/decrypted by a corresponding second encryption table into an original data value.

12. The apparatus in accordance with claim 11 wherein each of the first plurality of encryption tables is associated with a tables location address, and the second encryption tables have the tables location addresses a predetermined amount offset from that of the corresponding first encryption table.

13. The apparatus in accordance with claim 11 wherein said encryption/decryption module includes:
a table selector coupled to said first plurality of encryption tables and said track mixer, said table selector being adapted to associate a combined value in the series with a tables location address, wherein said table selector is further adapted to
select the encryption tables using the series of combined values if the data is to be transmitted or encrypted; and
select the encryption tables using the series of combined values with the predetermined offset if the data is received or to be decrypted.

14-15. (canceled)

16. The apparatus in accordance with claim 11, further comprising:
a look-up table providing an one-to-one association between each of the first encryption tables and the corresponding second encryption table.

17. The apparatus in accordance with claim 1 wherein the encryption table is capable of transforming each of possible data values into a corresponding encrypted/decrypted value which is also one of the possible data values different from the original data value.

18. The apparatus in accordance with claim 1 wherein said selection track generator includes:
a memory storing a plurality of source files; and
a track pattern manager coupled to said memory, adapted to generate a series of values from a selected source files.

19. The apparatus in accordance with claim 18 wherein said track pattern manager is further adapted to modify each of the series of values using setting parameters.

20. The apparatus in accordance with claim 18 wherein said track pattern manager is further adapted to select a mathematical operation to be used to combine the value of each track with other tracks.

21. An apparatus in accordance with claim 1, further comprising:
an identification code unique to said apparatus; and
a first database memory containing said first plurality of encryption tables and said second plurality of selection tracks as an encryption/decryption file associated with the identification code.

22. The apparatus in accordance with claim 21 wherein said first database memory further includes, as the encryption/decryption file:
a set of setting parameters capable of modifying values of each of said selection tracks and determining a manner of combination of each selection track to other tracks.

23. The apparatus in accordance with claim 21, further comprising:
a second database memory designated to store at least one second encryption/decryption file different from the encryption/decryption file on the first database memory.

24. The apparatus in accordance with claim 23 wherein the encryption/decryption file on the first memory is adapted to encrypt the second encryption/decryption file for transmission, or to decrypt the second encryption/decryption file which is encrypted.

25. The apparatus in accordance with claim 1, wherein each of the selection tracks has a key length by which the certain pattern of the track recurs.

26. The apparatus in accordance with claim 25, wherein the key length of a selection track is different from the key length of another selection track.

27. The apparatus in accordance with claim 26, wherein none of the key length is obtained by multiplying another key length by 2ⁿ, or by dividing another key length by 2ⁿ, where n is an integer.

28. The apparatus in accordance with claim 25, wherein differences among the key lengths are substantially smaller than the key lengths.

29. A method for encrypting/decrypting original data into encrypted/decrypted data, said method comprising:
providing a first plurality of encryption tables, each encryption table being capable of transforming a data value into an encrypted/decrypted value, the data value corresponding to a unit of the data, the encrypted/decrypted value corresponding to a unit of encrypted/decrypted data;
providing a second plurality of selection tracks, each selection track including a series of values having a certain pattern;
combining corresponding values of the selection tracks to produce a series of combined values;
selecting an encryption table for each unit of the data in accordance with a corresponding combined value in the series of combined values; and
transforming each unit of the data into a unit of encrypted/decrypted data using the encryption table selected for that unit.

30. The method in accordance with claim 29, further comprising:
selecting the second plurality of source files from among source files stored in a database memory; and
producing a series of values from each of the selected source files.

31. The method in accordance with claim 30, further comprising:
modifying each of the series of values using setting parameters.

32. The method in accordance with claim 31, further comprising:
selecting a mathematical operation to be used to combine the value of each track with other tracks.

33. The method in accordance with claim 32, further comprising:
pre-processing at least one of
said selecting the second plurality of source files,
said producing a series of values,
said modifying,
said selecting a mathematical operation, and
said combining corresponding values; and
storing in a database memory at least one of
the series of values produced from the selected source files,
the series of values modified by the setting parameters, and
the series of combined values.

34. The method in accordance with claim 29, further comprising:
selecting a data length of the unit.

35-37. (canceled)

38. The method in accordance with claim 29, further comprising:
synchronizing said selecting and said transforming so as to encrypt/decrypt a stream of data transmitted in real time.

39-40. (canceled)

41. The method in accordance with claim 29 wherein said first plurality of encryption tables include:
a first table bank including encryption tables adapted to transform an original data value into an encrypted value; and
a second table bank including encryption tables adapted to transform the encrypted value into the original data value.

42. The method in accordance with claim 29 wherein the first plurality of encryption tables includes:
first encryption tables adapted to transform the data value into the encrypted/decrypted value; and
second encryption tables adapted to transform the data value into the encrypted/decrypted value, each of the second encryption tables being capable of inverse-transforming the encrypted/decrypted value that is encrypted/decrypted by a corresponding first encryption table into an original data value, each of the first encryption tables being capable of inverse-transforming the encrypted/decrypted data value that is encrypted/decrypted by a corresponding second encryption table into an original data value.

43. The method in accordance with claim 42 wherein each of the first plurality of encryption tables is associated with a tables location address, said method further comprising:
associating the second encryption tables with the tables location addresses a predetermined amount offset from that of the corresponding first encryption tables,
selecting the encryption tables using the series of combined values if the data is to be transmitted or encrypted; and
selecting the encryption tables using the series of combined values with the predetermined offset if the data is received or to be decrypted.

44-45. (canceled)

46. The method in accordance with claim 42, further comprising:
providing a one-to-one association between each of the first encryption tables and the corresponding second encryption table.

47. The method in accordance with claim 29 wherein the encryption table is capable of transforming each of possible data values into a corresponding encrypted/decrypted value which is also one of the possible data values different from the original data value.

48. The method in accordance with claim 29 wherein said selecting an encryption table includes:
associating a combined value in the series with a tables location address;
selecting an encryption table associated with the tables location address.

49. A method for automatically setting up an encryptor/decryptor on an apparatus, the apparatus including an identification code unique to the apparatus and a setup file associated with the identification code, the setup file being capable of encrypting/decrypting data, said method comprising:
receiving the identification code from the apparatus;
retrieving the setup file associated with the identification code from a data base memory containing setup files;
creating a session file, including
selecting a set of encryption tables from among a plurality of encryption tables;
selecting a set of selection tracks from among a plurality of selection tracks, each of the selection tracks including a series of values having a certain pattern; and
selecting a set of setting parameters from among a plurality of setting parameters;
associating the session file with the identification code;
encrypting the information of the session file using the setup file; and
transmitting the encrypted information of the session file to the apparatus.

50. The method in accordance with claim 49 wherein the information of the session file includes:
the set of encryption tables;
the set of selection tracks; and
the set of setting parameters.

51. The method in accordance with claim 49 wherein the information of the session file includes at least one of:
indication of which encryption tables are to be used;
indication of which selection tracks are to be used; and
indication of which setting parameters are to be used.

52. The method in accordance with claim 49, further comprising:
storing, in a database memory, the information of the session file with an association with the identification code.

53. The method in accordance with claim 52, further comprising:
storing, in a second database memory at a different location, at least one of the set of encryption tables, the set of selection tracks, and the set of setting parameters with association with the identification code.

54. The method in accordance with claim 52 wherein the second database memory is accessible from the apparatus via a computer network.

55. The method in accordance with claim 49 wherein said selecting a set of selection tracks includes:
selecting a source file containing data capable of producing a certain pattern; and
selecting a software module capable of generating a certain pattern.

56. The method in accordance with claim 49 wherein said selecting a set of encryption tables includes:
selecting a set of encryption tables of the setup file.

57. The method in accordance with claim 49 wherein said selecting a set of selection tracks includes:
selecting at least one selection tracks of the setup file.

58. The method in accordance with claim 49 wherein said selecting a set of setting parameters includes:
selecting a least one setting parameter of the setup file.

59. A method for authenticating an apparatus having an identification code unique to the apparatus and a setup file associated with the identification code, the setup file being capable of encrypting/decrypting data, said method comprising:
receiving the identification code from the apparatus;
retrieving a setup file associated with the identification code from a data base memory containing setup files;
generating a sequence of values and transmitting the sequence to the apparatus;
encrypting the sequence using the retrieved setup file;
calculating a first check sum from the encrypted sequence;
receiving from the apparatus a second check sum which is calculated at the apparatus from an encrypted sequence using the setup file thereof;
determining if the second check sum matches the first check sum; and
authenticating the apparatus if the second check sum matches the first check sum.

60. An apparatus for automatically setting up an encryptor/decryptor on a second apparatus, the second apparatus including an identification code unique to the second apparatus and a setup file associated with the identification code, the setup file being capable of encrypting/decrypting data, said apparatus comprising:
means for receiving the identification code from the second apparatus;
means for retrieving the setup file associated with the identification code from a data base memory containing setup files;
means for selecting a set of encryption tables from among a plurality of encryption tables;
means for selecting a set of selection tracks from among a plurality of selection tracks, each of the selection tracks including a series of values having a certain pattern produced using a source file;
means for selecting a set of setting parameters from among a plurality of setting parameters;
means for associating the set of encryption tables, the set of selection tracks, and the set of setting parameters with the identification code;
means for encrypting the set of encryption tables, the set of selection tracks, and the set of setting parameters using the setup file; and
means for transmitting the encrypted set of encryption tables, the encrypted set of selection tracks, and the encrypted set of setting parameters to the second apparatus.

61. The apparatus in accordance with claim 60, further comprising:
means for storing, in a database memory, the set of encryption tables, the set of selection tracks, and the set of setting parameters with an association with the identification code.

62. The apparatus in accordance with claim 61, further comprising:
means for storing, in a second database memory at a different location, at least one of the set of encryption tables, the set of selection tracks, and the set of setting parameters with association with the identification code.

63. The apparatus in accordance with claim 62, wherein the second database memory is accessible from the second apparatus via a computer network.

64. An apparatus for authenticating a second apparatus having an identification code unique to the second apparatus and a setup file associated with the identification code, the setup file being capable of encrypting/decrypting data, said apparatus comprising:
means for receiving the identification code from the second apparatus;
means for retrieving a setup file associated with the identification code from a data base memory containing setup files;
means for generating a sequence of values and transmitting the sequence to the second apparatus;
means for encrypting the sequence using the retrieved setup file;
means for calculating a first check sum from the encrypted sequence;
means for receiving from the second apparatus a second check sum which is calculated at the second apparatus from an encrypted sequence using the setup file thereof;
means for determining if the second check sum matches the first check sum; and
means for authenticating the second apparatus if the second check sum matches the first check sum.

65. A program storage device readable by a machine, tangibly embodying a program of instructions executable by the machine to perform a method for encrypting/decrypting original data into encrypted/decrypted data, said method comprising:
providing a first plurality of encryption tables, each encryption table being capable of transforming a data value into an encrypted/decrypted value, the data value corresponding to a unit of the data, the encrypted/decrypted value corresponding to a unit of encrypted/decrypted data;
providing a second plurality of selection tracks, each selection track including a series of values having a certain pattern produced using a corresponding source file;
combining corresponding values of the selection tracks to produce a series of combined values;
selecting an encryption table for each unit of the data in accordance with a corresponding combined value in the series of combined values; and
transforming each unit of the data into a unit of encrypted/decrypted data using the encryption table selected for that unit.

66. A program storage device readable by a machine, tangibly embodying a program of instructions executable by the machine to perform a method for automatically setting up an encryptor/decryptor on an apparatus, the apparatus including an identification code unique to the apparatus and a setup file associated with the identification code, the setup file being capable of encrypting/decrypting data, said method comprising:
receiving the identification code from the apparatus;
retrieving the setup file associated with the identification code from a data base memory containing setup files;
selecting a set of encryption tables from among a plurality of encryption tables;
selecting a set of selection tracks from among a plurality of selection tracks, each of the selection tracks including a series of values having a certain pattern produced using a source file;
selecting a set of setting parameters from among a plurality of setting parameters;
associating the set of encryption tables, the set of selection tracks, and the set of setting parameters with the identification code;
encrypting the set of encryption tables, the set of selection tracks, and the set of setting parameters using the setup file; and
transmitting the encrypted set of encryption tables, the encrypted set of selection tracks, and the encrypted set of setting parameters to the apparatus.

67. A program storage device readable by a machine, tangibly embodying a program of instructions executable by the machine to perform a method for authenticating an apparatus having an identification code unique to the apparatus and a setup file associated with the identification code, the setup file being capable of encrypting/decrypting data, said method comprising:
receiving the identification code from the apparatus;
retrieving a setup file associated with the identification code from a data base memory containing setup files;
generating a sequence of values and transmitting the sequence to the apparatus;
encrypting the sequence using the retrieved setup file;
calculating a first check sum from the encrypted sequence;
receiving from the apparatus a second check sum which is calculated at the apparatus from an encrypted sequence using the setup file thereof;
determining if the second check sum matches the first check sum; and
authenticating the apparatus if the second check sum matches the first check sum.

68. A pseudo-random number generator, comprising:
a selection track generator adapted to generate a plurality of selection tracks, each selection track including a series of values having a certain pattern produced using a corresponding source file, said selection track generator including
a memory storing a plurality of source files; and
a track pattern manager coupled to said memory, adapted to generate a series of values from a selected source file; and
a track mixer coupled to said selection track generator, adapted to combine corresponding values of the selection tracks to produce a series of combined values, wherein said track manager is further adapted to modify each of series of values using setting parameters.

69-70. (canceled)

71. The pseudo-random number generator in accordance with claim 68 wherein said track pattern manager is further adapted to select a mathematical operation to be used to combine the value of each track with other tracks.

72. The pseudo-random number generator in accordance with claim 68 wherein each of the selection tracks has a key length by which the certain pattern of the track recurs.

73. The pseudo-random number generator in accordance with claim 72 wherein none of the key length of the selection track is equal to another key length.

74. The pseudo-random number generator in accordance with claim 72, wherein none of the key length is obtained by multiplying another key length by 2ⁿ, or by dividing another key length by 2ⁿ, where n is an integer.

75. The pseudo-random number generator in accordance with claim 73, wherein differences among the key lengths are substantially smaller than the key lengths.
